(19) United States
(12) Patent Application Publication
(10) Pub. No.: US 2010/0262449 A1
(43) Pub. Date: Oct. 14, 2010

(54) CONTEXT BASED MOBILE MARKETING

(75) Inventors: Jeffrey J. Monteforte, Seven Hills, OH (US); Greg Muffler, North Royalton, OH (US); Dennis J. Gaukin, Broadview Heights, OH (US)

Correspondence Address: TUROCY & WATSON, LLP, 127 Public Square, 57th Floor, Key Tower, CLEVELAND, OH, 44114, US

(73) Assignee: ACCESS MOBILITY, INC., Cleveland, OH (US)

(21) Appl. No.: 12/421,321

(22) Filed: Apr. 9, 2009

(51) Int. Cl. G06Q 10/00; G01C 21/00; G06Q 30/00; H04M 3/42

(52) U.S. Cl. 705/8; 701/300; 705/10; 705/34; 455/456.3; 705/14.66

(57) ABSTRACT

A marketing system is provided that leverages context information including location as well as extrinsic data, among other things. Advertisers can create and register advertisements or promotional offers with the system. System users can create a profile comprising preferences that identify desirable advertisement. A correlation component is then employed to match advertisements to users as a function of preferences, location, and extrinsic data. Subsequently matched advertisements are delivered to a user, for example by way of a mobile computing device.

### BACKGROUND

Mobile devices continue to be wildly popular amongst most people. In the not so distant past, mobile devices where confined to bulky cell phones, pagers, and personal digital assistants (PDAs) utilized primarily for business purposes. Advances in technology and reductions in cost created much smaller and affordable devices, such that nowadays most everyone owns at least one mobile device. For instance, mobile phones, music players, and global positioning system (GPS) devices, gaming systems, and electronic book readers are increasingly pervasive. Furthermore, smart phones and other hybrid devices are becoming very popular since they provide a combination of functionality in a single device.

Marketing and more specifically advertising has changed over time with technology. At one time, television, radio, and mail were the primary means for advertising. Accordingly, advertising was accomplished by way of commercials and direct mailings. With the advent of the Internet, advertisers were afforded additional dissemination mechanisms including e-mail and search. Consequently, advertisements are now also provided in the form of or within e-mail, embedded with Web pages, and proximate to or as search results, among other things. The proliferation of mobile devices now provides advertisers with yet another way to reach potential customers. Further yet, advertisers are now seeking to exploit location information enabled by many mobile devices. Such functionality is often referred to as a location-based service (LBS) or alternatively location-based advertising (LBA).

Location-based services supply information as a function of the geographical position of a mobile device. One or more location mechanisms can be utilized by such services including GPS, triangulation, and local proximity technologies such as Bluetooth, infrared, wireless local area network (WLAN), and radio frequency identification (RFID), among other things. Applications can then utilize the determined location to aid navigation or focus search results. Moreover and as previously mentioned, advertisements or the like can be transmitted to users based on their location as determined via their mobile device. For example, when a mobile phone is determined to be within a specified distance of a restaurant, a text message can be sent to the user including a promotional code associated with some discount, such as 10% off a meal or a free appetizer with the purchase of two entrees.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to context based mobile marketing. Herein, context includes more information than simple geographic location. Among other things that can be taken into account are a user profile, user preferences/settings, advertiser preferences/settings, and/or extrinsic data. Advertisements can thus be correlated with and delivered to users or consumers with much specificity. Consequently, consumers receive advertisements that are more relevant and advertisers can better target consumers.

In accordance with one aspect of the disclosure, a mobile marketing system is positioned between a plurality of consumers and advertisers to facilitate provisioning of advertisements including promotional offers, coupons, or the like. Both consumers and advertisers can register with the system and provide pertinent information including, without limitation, profiles, preferences, and/or settings. Furthermore, facilities can be provided to aid advertisers in campaign generation and management. Based on consumer and advertiser information as well as otherwise acquired context information, advertisements can be matched with consumers and subsequently delivered thereto. Furthermore, the unique position of the system between a number of consumers and advertisers also enables transactional information about advertisement matching and promotional offer redemption to be leveraged to aid subsequent advertisement correlation.

According to another disclosed aspect, at least a portion of the mobile marketing system can be provided as a mobile device application. For example, if the mobile device corresponds to a phone, the phone can include a plurality of interfaces to acquire consumer information as well as a means for pushing advertisements to users, among other things.

Mechanisms are also disclosed herein to facilitate acquisition of pertinent information from other than straightforward text-box-based graphical interfaces. In particular, calendars can be utilized not only to specify particular events but also to associate information associated with purchase of goods or services, for instance for birthdays, anniversaries, and holidays, among others. Further, mechanisms are provided for retrieving information from shopping lists and with respect to kits.

According to yet another aspect of the disclosure, gathering contextual information can facilitate various schemes for matching and delivering advertisements. In one instance, advertisements can be provided to redirect consumers away from competitors. In another instance, purchasing behavior and other models can be employed to aid affording users with relevant advertisements at appropriate times. Further, rather than targeting solely individual consumers, group information can be leveraged.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a mobile marketing system in accordance with an aspect of the subject disclosure.

FIG. 2 is an exemplary environment in which the mobile marketing system of FIG. 1 can be employed according to an aspect of the disclosure.

FIG. 3 is a block diagram of a representative context component in accordance with a disclosed aspect.

FIG. 4 is a block diagram of a representative consumer interface component according to a disclosed aspect.

FIG. 5 is a block diagram of a representative advertiser interface component in accordance with an aspect of the disclosure.

FIGS. 6-11 are exemplary screenshots associated with advertiser registration, account setup and advertisement generation in accordance with an aspect of the disclosure.

FIGS. 12-14 are exemplary screenshots pertaining to consumer registration and account setup according to a disclosed aspect.

FIG. 15 is a sample screenshot of a text message on a mobile phone notifying a user of an offer of interest according to an aspect of the disclosure.

FIG. 16 is an exemplary screenshot presenting consumer offers in accordance with an aspect of the disclosure.

FIGS. 17-20 are exemplary screenshots that provide campaign information to an advertiser according to a disclosed aspect.

FIG. 21 is a block diagram of a representative correlation component in accordance with an aspect of the disclosed subject matter.

FIG. 22 is a block diagram of a representative delivery component according to a disclosed aspect.

FIGS. 23a-b are exemplary screenshots associated with a mobile device according to a disclosed aspect.

FIGS. 24a-b are sample screenshots with respect to a mobile device in accordance with an aspect of the disclosure.

FIG. 25 is a block diagram of a representative consumer interface component according to a disclosed aspect.

FIG. 26 is a flow chart diagram of a method of mobile advertisement in accordance with an aspect of the disclosure.

FIG. 27 is a flow chart diagram of a method of employing advertisements in accordance with a disclosed aspect.

FIG. 28 is a flow chart diagram of a method of advertising as a function of calendar entries according to a disclosed aspect.

FIG. 29 is a flow chart diagram of a method of advertisement distribution according to an aspect of the disclosure.

FIG. 30 is a flow chart diagram of a method of advertising based on behavior model according to a disclosed aspect.

FIG. 31 is a flow chart diagram of a method of group advertising in accordance with an aspect of the disclosed subject matter.

FIG. 32 is a flow chart diagram of a method of offer redemption in accordance with a disclosed aspect.

FIG. 33 is a schematic block diagram illustrating a suitable operating environment for aspects of the subject disclosure.

FIG. 34 is a schematic block diagram illustrating a suitable operating environment for aspects of the subject disclosure.

FIG. 35 is a schematic block diagram of a sample-computing environment.

### DETAILED DESCRIPTION

Systems and methods pertaining to mobile marketing are described in detail hereinafter. Mechanisms are employed to connect advertisers to potential consumers with fine granularity by employing context information including not only location but also extrinsic data, among other things. Further, preferences can be specified to control delivery of advertisements. A correlation component can be employed to perform matching of advertisements with users as a function of context as well as user profiles, user preferences/settings, and/or advertiser preferences/settings. Subsequently, matching advertisements are delivered to users, for instance by way of a user's mobile device. Collection and employment of copious amounts of information can substantially improve advertising campaign effectiveness as well as consumer satisfaction. For example, if a three-hundred and sixty degree view of consumers can be constructed, the consumers will be provided with highly relevant advertisements, which is advantageous to both the consumers and advertisers.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

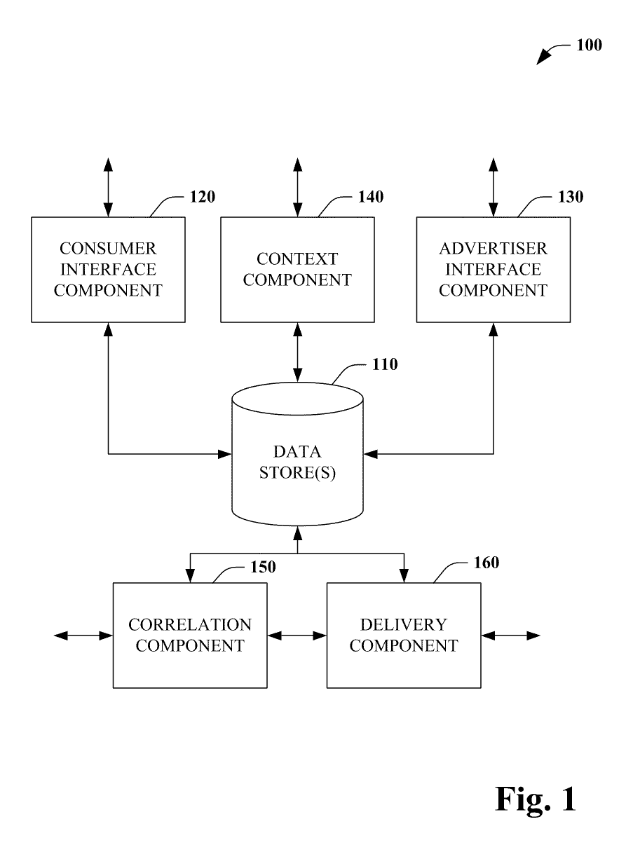

Referring initially to FIG. 1, a mobile marketing system 100 is illustrated in accordance with an aspect of the claimed subject matter. The system 100 includes one or more data stores 110 that house data pertaining to at least advertisers and consumers. The number, type, and configuration of data stores can vary. For example, the data store(s) 110 can be embodied as one or more database and data warehouse systems. Consumer interface component 120, advertiser interface 130, and context component 140 are communicatively coupled to the data store(s) 110 and provision different types of data for storage and subsequent employment to facilitate correlation and delivery of advertisements.

The consumer interface component 120 is a mechanism that facilitates collection of consumer or system user information. The extent of such information can vary but in general concerns at least identification of a user and a means for receiving advertisements. For example, a consumer can provide his/her name and specify a mobile computing device such as a mobile phone to receive advertisements. The consumer interface can also collect profile and/or preference information. A profile can include among other things, address, date of birth, gender, profession, income, ethnicity, religion, and/or group memberships. User preferences or settings can include, without limitation, categories of products/services of interest, companies of interest, keywords, advertisement delivery schedule (e.g., days of week, time of day . . . ), and means of notification and/or delivery (e.g. text message, email, local application . . . ). Alone or in combination, the user profile and/or preferences can act as advertisement filters, as will be described further infra.

The advertiser interface component 130 is a mechanism that aids retrieval of advertiser related information such as advertiser or company, and advertisement or advertisement campaign information, among other things. For example, information can be collected regarding the location and/or particular stores for which advertisements or more specifically promotional offers will be valid. Further, advertisement interface component 130 can facilitate construction of a promotion and specification or particular preferences to control distribution such as category, keywords, and age range. Specifics regarding the promotion can also be acquired including when the advertisement will be sent and the total number of advertisements to be sent or variations thereof (e.g., impressions, views, activations . . . ). Such information can also be referred to as an advertisement profile.

The context component 140 acquires and contributes context information to the data store(s) 110. Context relates generally to conditions that occur surrounding a consumer and/or advertiser, among other things. As will be discussed, further below, context can include, without limitation, user location information, and other extrinsic data. As will further be appreciated in light of later discussion, context provides yet another factor that can be considered when determining whether or not to provide a particular advertisement to a user.

The system 100 also includes correlation component 150 communicatively coupled to the data store(s) 110. The correlation component 150 can acquire data/information at least from the data store(s) 110 for use in correlating or matching advertisements to particular users. Matching can range from relatively simple to quite complex. For example, matching can be accomplished by determining whether or not a consumer and advertiser filters match. Additionally or alternatively, the correlation component 150 can engage in a more predictive assessment, for instance, where it infers matches as a function of a collection of information for which filters or preferences have not be explicitly identified. In one particular embodiment, the correlation component 150 can make predictions based affinity groups in which a user is deemed a member.

Delivery component 160 is communicatively coupled to the correlation component 150 as well as the data store(s) 110. Upon receipt or retrieval of matching advertisements from the correlation component 150, the delivery component 160 can deliver the advertisement or advertisement related information to a user by way of some computing device associated with the user. By way of example and not limitation, the delivery component 160 can send a text message (e.g., Short Message Service (SMS) communication), multimedia message (Multimedia Messaging Service (MMS) communication), e-mail (electronic mail), or an application message including the advertisement and/or information pertaining to the advertisement.

Further, the delivery component 160 can utilize information from the data store(s) 110 to determine if, when, and/or to which device the advertisement is sent. For example, a user may set preferences that dictate delivery. Additionally or alternatively, the delivery component 160 can determine or infer delivery specifics based on context information. For instance, if it can be determined that a user is likely skiing down a slope based on temperature, weather conditions, altimeter, and accelerometer data, the delivery component 160 would probably wait to transmit the advertisement until he/she is in line at a lift or in lodge café. Furthermore, where a user employs more than one device capable of receiving advertisements the delivery component 160 can also determine or infer to which device a user would prefer to receive an advertisement and send it to that device.

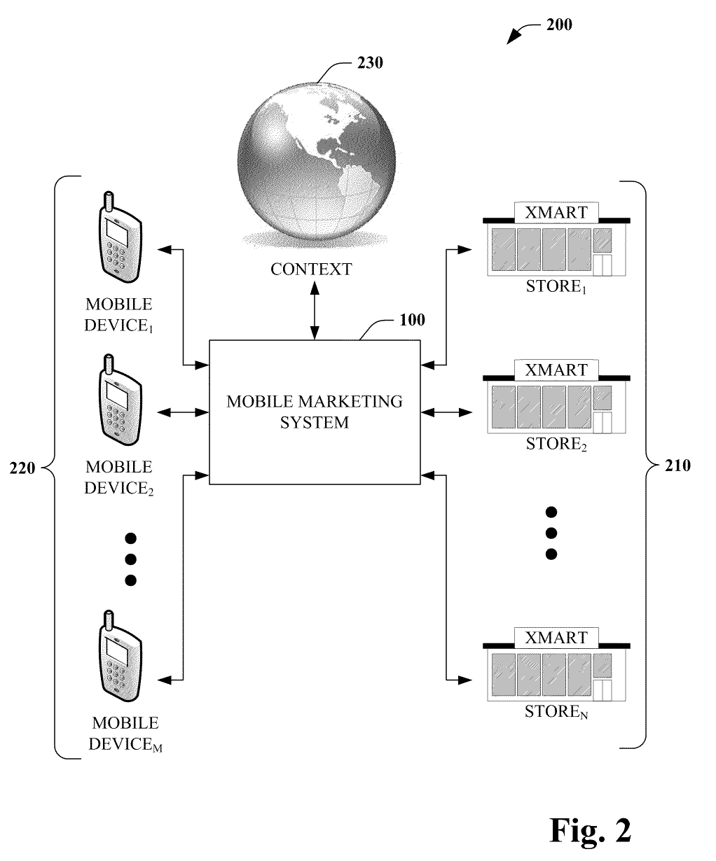

FIG. 2 illustrates an exemplary environment 200 in which the mobile marketing system 100 can be utilized. In particular, the mobile marketing system 100 is positioned between a plurality of stores 210 (STORE₁-STORE_{N}, where N is greater than or equal to one) and mobile devices 220 (MOBILE DEVICE₁-MOBILE DEVICE_{M}, where M is greater than or equal to one). The stores 210 can be traditional physical stores and/or online stores. Further, it should be noted that one or more stores 210 could correspond to the same store yet in a different location such as the case in chain or franchise stores. The mobile devices 220 can correspond to any computing device that is able to receive an advertisement. For example, a mobile device can be embodied as a mobile phone, a palmtop computer, a personal digital assistant (PDA), a music player, a GPS receiver, or an electronic book reader, among other things. Where a device cannot acquire such a message directly over some communication framework (e.g., cellular phone, Internet . . . ), it can be afforded indirectly by way of some other device (e.g., Bluetooth, wired connection . . . ). Furthermore, it should be noted that although described as mobile, such device 220 is not so limited and as such can also be substantially immobile. In addition to information provided by stores 210 and mobile devices 220, the mobile marketing system 100 can also acquire contextual information or context 230 from some other place, location, or supplier.

The environment 200 is provided to facilitate clarity and understanding with respect to aspects of the claimed subject matter. As shown, the mobile marketing system 100 is positioned between the stores 210 and mobile devices 220. This position is conceptually significant. In one embodiment, the mobile marketing system can be employed by one store and one or more devices 220. In this situation, the mobile marketing system 100 has access to a plurality of users and information regarding their interaction with the sole store 210. However, where multiple stores 210 are employed in conjunction with multiple mobile devices 220, the mobile marketing system 100 acquires information about numerous users and their interactions with a plethora of stores. In this scenario, this information gain is beneficial to both users and stores. For example, information about advertisements provided to and/or offers redeemed by users from multiple stores can be utilized to further refine correlation to provide more users with more relevant advertisements advertisers with more effective campaigns. Further, such information can be fed back to advertisers to allow them to readjust or retarget advertisement campaigns.

More specifically, a consumer's mobile device 220 can be electronically linked to a mobile marketing system database. This link, over time, can provide discrete snapshots of transactional interaction data that illustrate how the consumer responds to an advertisement. Advertisement details such as specific product or service, type and size of discount, how quickly an offer is activated, where the consumer was traveling and other significant time-location based aspects can be collected. A consumer's experience can be associated with the transactional interaction data producing a three hundred and sixty degree view of the consumer's behavior. Still further yet, each consumer's transactional interaction data or transactional exhaust can be leveraged to aid target advertisement generation and advertisement correlation, for example based on affinity groups or the like.

It is to be appreciated that while the mobile marketing system 100 can reside between stores 210 and devices 220, implementations of the system need not provide such distinct separation. By way of example and not limitation, at least a portion of the mobile marketing system functionality can be resident on mobile devices 220. For instance, a mobile device 220 can include an application executed thereon that communicates with an external server as needed. The functional split can also be adjusted as a function of capabilities (e.g., dumb vs. smart device) and substantially in real-time based on device and/or server load or failure, among other things.

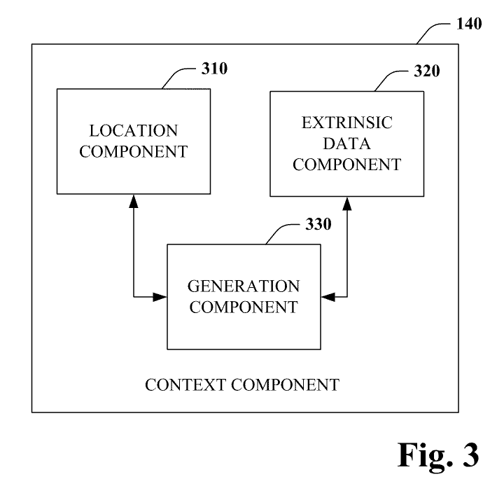

Turning attention to FIG. 3, a representative context component 140 is illustrated in accordance with an aspect of the claimed subject matter. As previously mentioned, the context component 140 facilitates collection of information regarding conditions surrounding a consumer and/or advertiser, among other things. One such piece of information is user and advertiser location, which can be acquired by location component 310. Location can be obtained in a variety of manners. For example, the location component 310 can collect this information from a user (e.g., city, state, zip code . . .). Additionally or alternatively, location information can be acquired from a mobile computing device. For example, a device GPS receiver and/or wireless communication (e.g., cellular triangulation, IP address location . . . ) can be employed to identify location of which location component 310 can receive or retrieve. The location component 310 can also acquire location information from third party services and/or devices (e.g., mobile GPS, car navigation system . . . ). Other options are also available including the use of RFID (Radio Frequency Identification) tags, proximity sensors, or geo-fencing. For instance, location can be determined when a user moves within a set distance of a proximity sensor or into or out of a geo-fence. While location can determined at a single point in time, it is also to be appreciated that it can be acquired in substantially real-time to enable a user's movement to be tracked, for example. Furthermore, the location component 310 can collect location from multiple suppliers and determine location based on aggregated information.

Moreover, context can include more than simple consumer and advertiser location. In particular, extrinsic data component 320 can receive, retrieve, or otherwise obtain or acquire additional data or information that is useful in advertisement correlation. As used herein, extrinsic data excludes location or explicitly specified profile or preference information, unless otherwise clearly stated. Extrinsic data, however, does include at least that which is outside control of either a consumer or advertiser. Examples of such data include, without limitation, time, temperature, weather, altitude, barometric pressure, time of day, and day of week. Furthermore, extrinsic data can also refer to data or information that is extrinsic to the advertiser while it may be at least to a degree intrinsic to or within control of the consumer. For instance, consider a consumer's proximity to other consumers. The extrinsic data component 320 can acquire this information in a variety of different ways including via sensors (e.g., user device, external, environmental, proximity . . . ) and third party services, among others. For example, temperature can be determined from a thermometer associated with a mobile device or from a weather service.

Context component 140 can also optionally include a generation component 330 that can produce additional context data based at least upon information from location component 310 and/or extrinsic data component 320. More specifically, the generation component 330 can utilize deductive reasoning, and/or inferences, among other things, to produce higher-level context information from lower-level pieces of context information and/or missing or unavailable information. For example, even if temperature is not known, other information such as altitude, location, season, and month, among other things can be utilized to estimate a temperature.

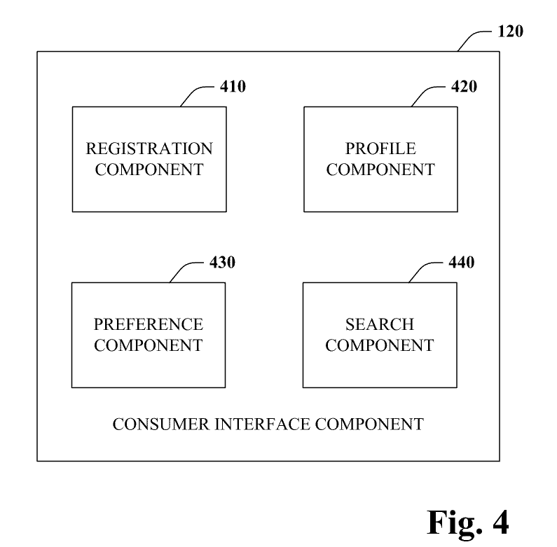

Referring to FIG. 4, a representative consumer interface component 120 is illustrated in accordance with an aspect of the claimed subject matter. The consumer component 120 provides a mechanism for a user or consumer to input data and interact with a mobile marketing system. As shown, the consumer component 120 includes a registration component 410, profile component 420, preference component 430, and search component 440.

The registration component 410 enables a user to register with a mobile marketing system and thereby make them eligible to receive advertisements. For example, the registration component 410 can afford one more graphical user interfaces or wizards to prompt users to enter such information as name, address, phone number, email or the like. A user account can subsequently be created after user information is validated, for instance by sending an email which includes an activation link.

The profile component 420 provides a mechanism for capturing user information about a user or a profile. For example, profile information can include similar things requested during registration as well as other information such as but not limited to birth date, gender, marital status, ethnicity, religion, group affiliations, profession, and home ownership status. Various other information can be entered that aid in defining and/or describing a user. Of course, none of this information is strictly necessary, but any profile information added can later be employed to facilitate location of relevant advertisements.

The preference component 430 facilitates input and receipt of user advertisement preferences or settings. By way of example and not limitation, a user can select categories and subcategories of goods and services of interest, and input keywords and brand/merchant preferences. Other settings can also include size of offers, maximum bid, frequency, privacy settings, temporary settings such as travel, vacation, expiration, and work, and a professional setting. Furthermore, a user can utilize the preference component 430 to specify delivery times and means of delivery and/or notification (e.g. email, SMS, MMS . . . ).

The search component 440 provides a mechanism to search for or otherwise locate advertisements of interest. More specifically, the search component 440 accepts advertisement queries in various forms and returns matching results. In other words, rather than sitting back and waiting for advertisements to be provided to them, users can proactively attempt to locate and acquire advertisements of interest.

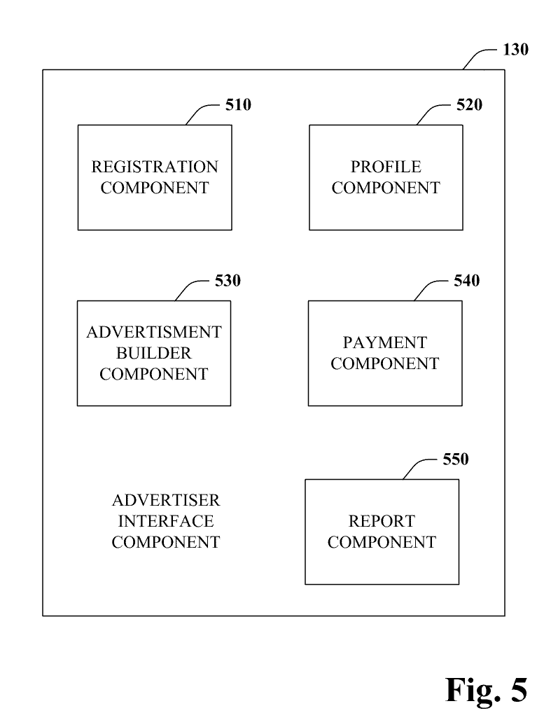

FIG. 5 depicts a representative advertiser interface component 130 in accordance with an aspect of the claimed subject matter. Similar to the consumer component 120, the advertiser component 130 includes a registration component 510 and a profile component 520. The registration component 510 is a mechanism for registering an advertiser or creating an advertiser account. Information can be input utilizing one or more interfaces. Registration information can include, among other things, company name, federal tax id, address, phone, number contact person, and email. After such information is provided and validated via one or more mechanisms (e.g., e-mail activation, challenge response test . . . ), profile information can be entered in a like manner. In addition to registration information, profile information can include business structure information and the identification of additional store information (e.g., chain stores, franchises) and/or information about a particular advertisement or campaign.

The advertiser component 130 also includes an advertisement builder component 530. As the name suggests, the advertisement builder component 530 facilities construction of advertisements and/or advertising campaigns. Although not limited thereto, in accordance with one embodiment a series of graphical user interfaces can be presented to an advertiser that guides him/her through such a process. It should be appreciated that preferences or settings can be associated with advertisements at this point including such things as categories, subcategories, keywords, gender, age range, interests, and hobbies, among other things. Further yet, such settings can relate to advertisement and/or campaign validity including but not limited to validity dates (e.g., start date and end date), number of times a user can receive an advertisement, delivery schedule and maximum number of impressions. Together the preferences and settings relating to an advertisement can comprise an advertisement profile.

An advertisement generated by builder component 530 can take any form that draws attention to or promotes some product or service. Accordingly, the advertisement can simply identify a product via image, audio, video, and/or scent for instance. However, advertisements that are more complex are contemplated including, without limitation, promotions, and/or use of coupons. Furthermore, presentation can differ. In one embodiment, promotional coupons can be produced that include either a promotional alphanumeric code or bar code, for instance. Further, the entire coupon including the promotional code need not be sent initially. For instance, a consumer can be notified of such a coupon first with a description of the product and/or service offer. This can be termed and offer impression. Subsequently, if interested, the consumer request more details including the coupon and promotional code. In other words, the coupon can be activated. Such a request or activation can correspond to clicking on the notification to initiate download of the coupon, texting a message “GET,” sending an e-mail, or placing a call, inter alia. Further, it is to be noted that the advertisement can include or be associated with a host of other information to aid consumers including such things as an advertiser's address and phone number, a map to one or more locations and a link to the advertiser's website, for example. Still further yet, while promotional code can aid in tracking offer usage (e.g., impression, activation, impression), a unique tracking code can also be associated therewith for that purpose.

Payment component 540 is a mechanism to enable billing or invoice generation and receipt of payment from advertisers. Similar to other advertiser components, various interfaces, graphical or otherwise, among other things, can be employed to provide such functionality. Variations are likely since a multitude of different payment agreements and/or arrangements can be employed. In accordance with one embodiment, an advertiser can be afforded an invoice generated as a function of impressions, activations, and redemptions. Impressions refer to notifications of offers. Request and receipt of the actual offer are activations, and redemptions refer to purchases made that take advantage of an offer. Additionally or alternatively, payment component 540 can include or be associated with a separate component (not shown) to provide auction functionality to advertisers, for example to bid against each other for the right to afford a user an advertisement in a particular context. It is also to be noted that a user can provide the payment component 540 with a budget associated with the number of impressions, activations, and/or redemptions in an attempt to cap cost.

Report component 550 provides information about the performance of an advertisement campaign to an advertiser. For example, number of impressions, activations, and redemptions related to a promotion can be provided. Further, additional information or characteristics of particular consumers can be afforded including those that (1) received an offer but did not activate it, (2) received the offer and activated the offer but did not redeem it, and (3) received the offer, activated the offer, and redeemed the offer. Overall, such information aids advertiser in determining advertisement effectiveness and enables subsequent campaigns to be improved.

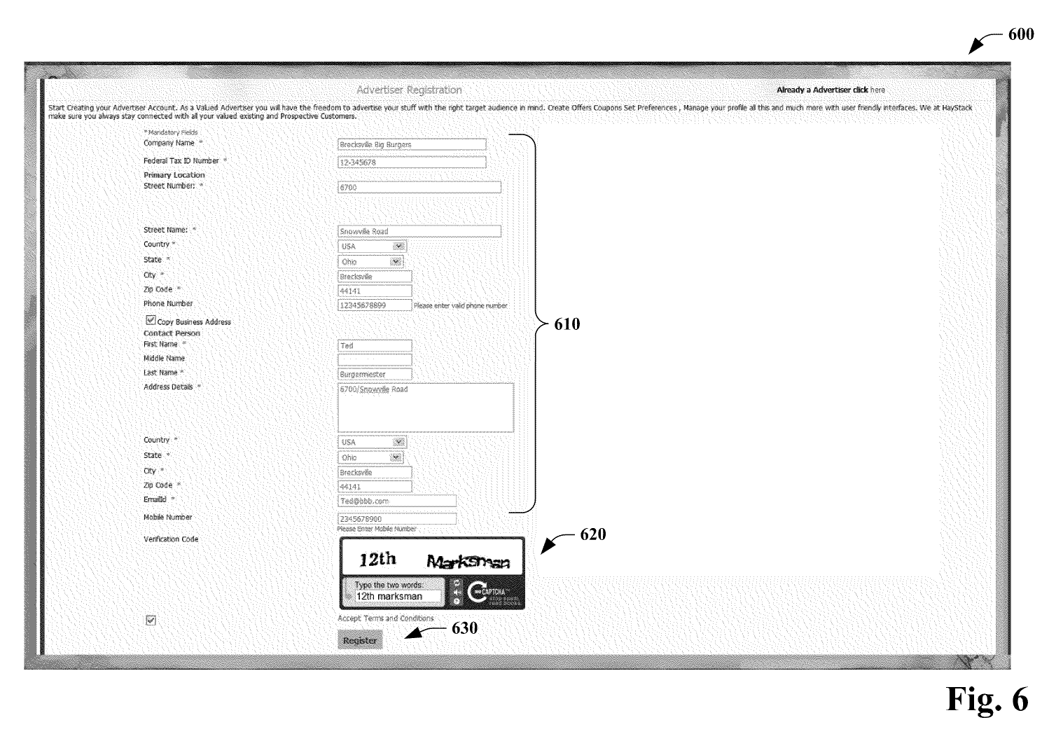

FIGS. 6-20 are exemplary screenshots that illustrate various aspects of the claimed subject matter. More particularly, the screenshots provide a sample walk through of some features from both the advertiser and consumer side. It is to be appreciated that the subject claims are not intended to be limited by the screenshots. Text, graphics, audio, and/or video can be combined in seemingly limitless combinations and permutations. The screenshots of FIGS. 6-20 provide a single combination to aid clarity and understanding of at least a portion of claimed features.

Turning attention to FIG. 6, a screenshot 600 is provided to enable advertiser registration. Registration is the first step in creating an advertiser account, which will subsequently enable an advertiser to create target advertisements, set preferences and manage a campaign, among other things. As shown, there are a plurality of text boxes for providing advertiser information 610 including company name, federal tax identification number, company address, contact person name, physical address, e-mail address, and mobile phone number. Also included is a challenge response test 620 or more specifically a CAPTCHA (Completely Automated Public Turing Test to tell Computers and Humans Apart) to verify that a human has completed the information. Finally, a user can click on the “Register” button 630 after completing all mandatory information and agreeing to the terms and conditions. Subsequently, an e-mail can be sent to the contact person to activate the advertiser account.

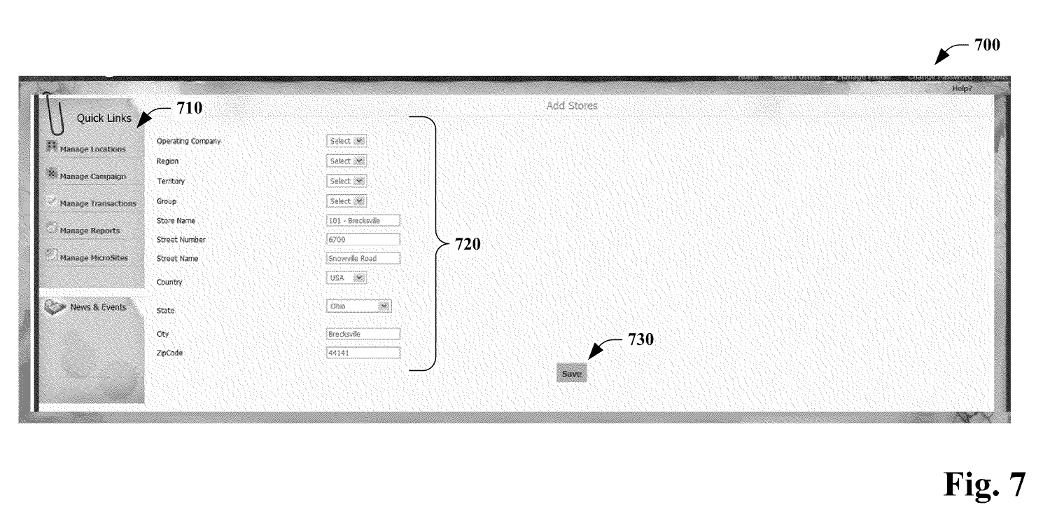

Once an advertiser activates an account, screenshot 700 of FIG. 7 can be presented. As illustrated, a “Quick Links” section 710 can be provided that allows a user to easily navigate to other pages to manage locations, campaigns, transactions, reports or micro-sites. Screenshot 700 specifically pertains to adding stores. Accordingly, a number of text boxes and drop down menus 720 are provided to aid collection of particular store information such as operating company, region, territory, group, store name, store number, and address. Once completed “Save” button 730 can be selected to save the specific store. The same procedure can be utilized to add multiple stores.

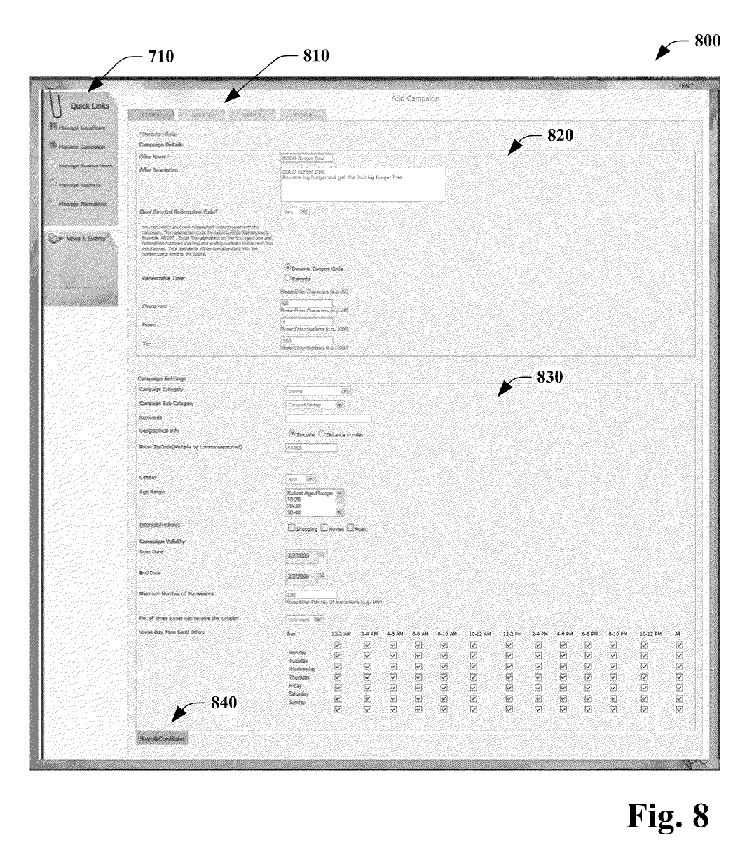

An advertiser can generate an advertisement as shown with respect to screenshot 800 of FIG. 8. Similar to screenshot 700, screenshot 800 includes a “Quick Links” section to facilitate navigation. Moreover, adding a campaign can be divided into distinct steps as captured by tabs 810 in which “Step 1” is active. Here, there are two portions: one for providing campaign details 820 and the other for campaign settings 830. Each portion includes a plurality of graphical user interface elements such as text boxes, drop down menus and check boxes to facilitate data entry. In campaign details portion 820 information is requested including an offer name “BOGO Burger Deal,” offer description “Buy one burger and get a second burger free,” redemption code, redemption type (e.g., dynamic coupon code, bar code . . . ), characters, as well as to and from. Campaign portion 830 requests information including campaign category and subcategory (e.g., Dining—Casual Dining), keywords for matching the advertisement, geographical information, zip code, gender, age range (e.g., 10-20, 21-30, 31-40 . . . ), interests/hobbies (e.g. shopping, movies, music . . . ), campaign start and end dates, a maximum number of impressions, a number of times a user can receive an advertisement, and a day or schedule for sending offers (e.g., day of week, time of day). Once information is entered, the “Save & Continue” button 840 can be selected to save the information and continue campaign construction.

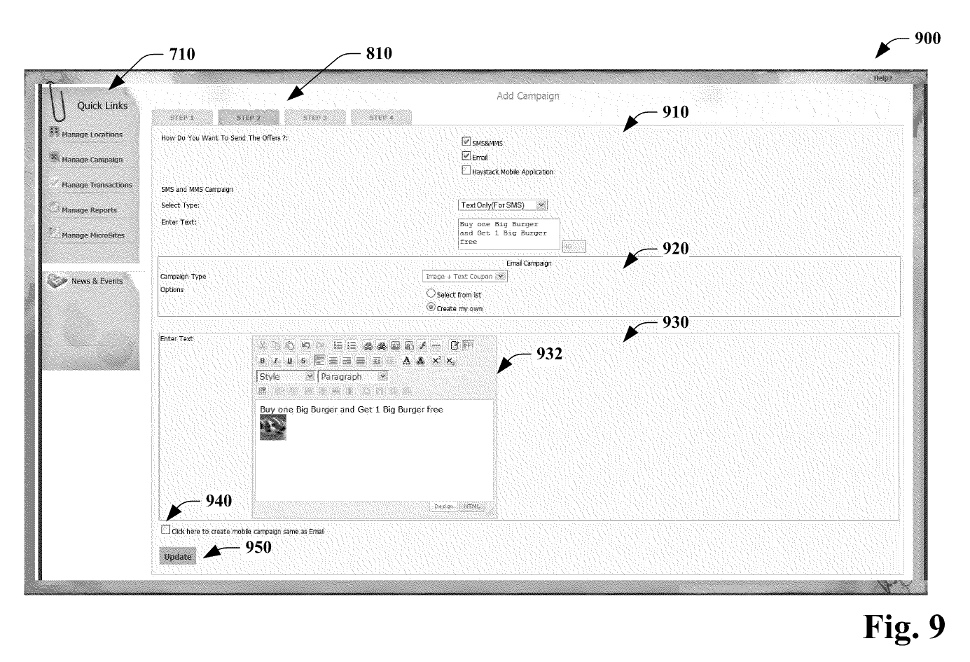

FIG. 9 illustrates a screenshot 900 that corresponds to the next step in advertisement campaign construction. In addition to the “Quick Links” portion 710 and tabs 810 previously described, screenshot 900 includes three additional portions or sections 910, 920 and 930 for acquiring information. Again, a number of text boxes, drop down menus, checkboxes, and buttons are used. Section 910 requests information about how offers are sent such as via SMS and MMS, e-mail, or by mobile application. Further information is also collected for SMS and MMS campaigns including type (e.g., text only, text and images . . . ) as well as a text description of the offer. Section 920 concerns e-mail campaigns. Input is acquired regarding the type and how it is to be constructed (e.g., from a list, created from scratch . . . ). Section 930 provides functionality for building an advertisement. In particular, an editor 932 can be spawned for use in construction. As shown, a buy one get one free burger coupon is constructed including an image. Below the building section 930, a button 940 is provided for selection if the advertiser would like to create a mobile campaign that is the same as a created e-mail campaign. Once complete, “Update” button 950 can be selected to save changes made.

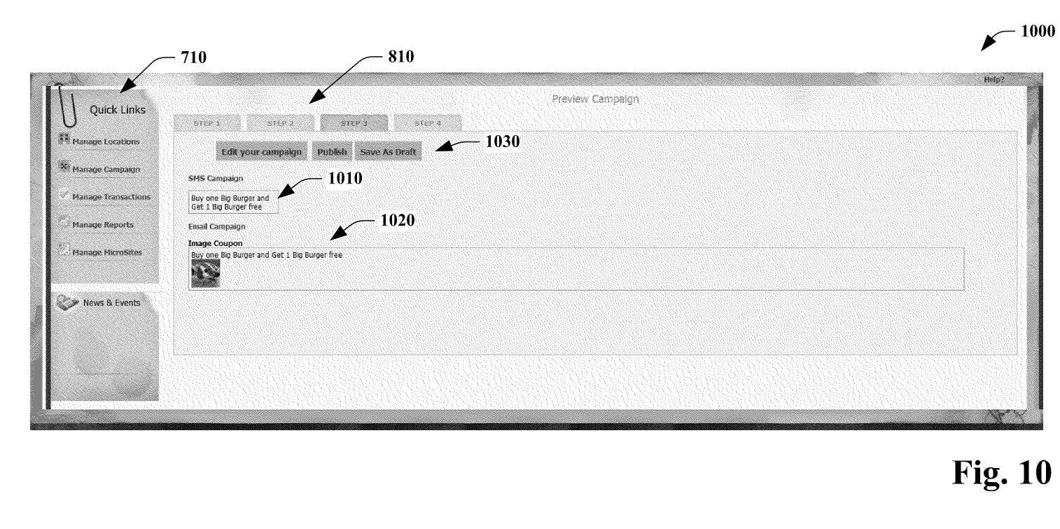

Screenshot 1000 of FIG. 10 pertains to a preview of a campaign. Here, the previously created text message or SMS campaign 1010 is displayed as “Buy one Big Burger and Get 1 Big Burger free.” The corresponding image coupon 1020 is shown below including the same text description with an image. Various buttons 1030 are also provided selection of which allows an advertiser to edit the campaign, publish the campaign or save the campaign as a draft.

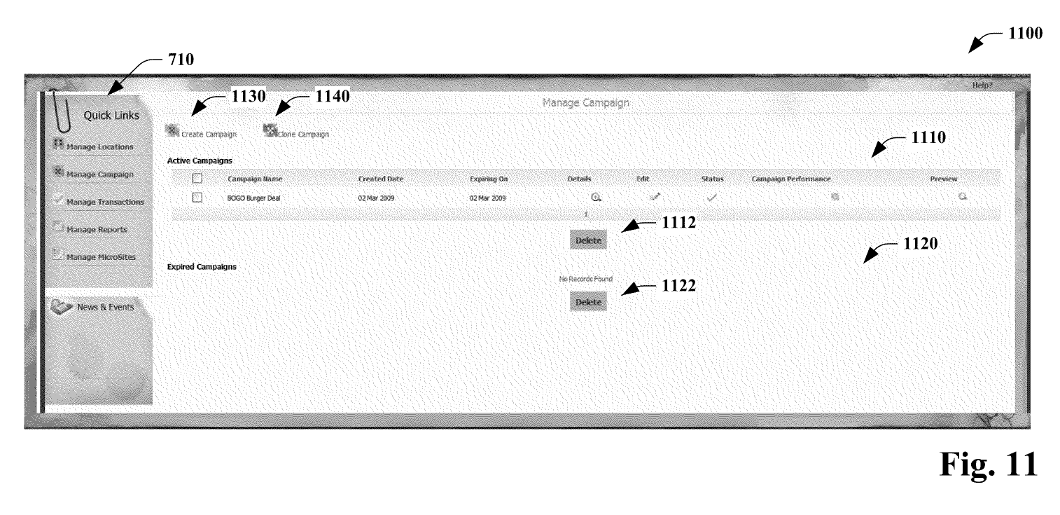

Screenshot 1100 of FIG. 11 depicts a graphical user interface for managing advertisements or campaigns. As shown, there are two portions 1110 and 1120 for listing active campaigns and expired campaigns, respectively. Further, there are two delete buttons 1112 and 1122 for deleting one or more listed campaigns. In accordance with the ongoing walkthrough, there is only one active campaign, namely the “Burger Deal.” Within each listing, information is provided including the campaign name, creation date, and expiration date, among other things. Still further yet, there are links to functionality for creating a new campaign 1130 and cloning a current campaign 1140.

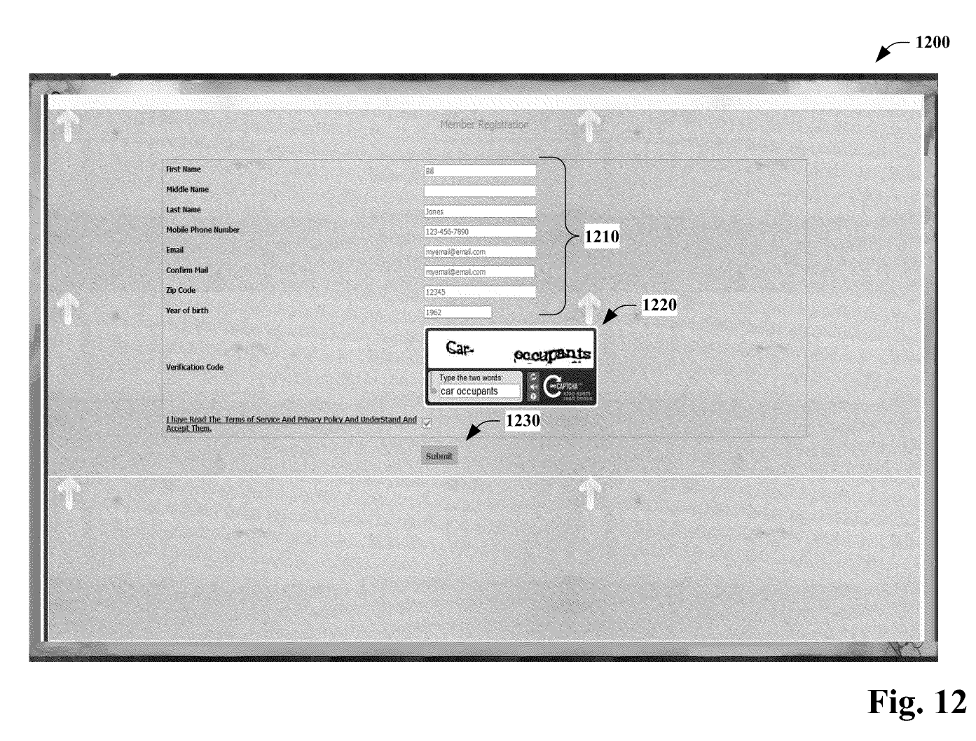

FIGS. 12-15 provide screenshots that facilitate interaction with users or consumers. Wither respect to FIG. 12, a screenshot 1200 is provided illustrating a manner in which a consumer can register with the system and thereby become a member. As depicted, the member registration screenshot 1200 can collect user information via a number of text boxes 1210. In particular, such information includes first name, middle name, last name, mobile phone number, e-mail zip code, and year of birth. Challenge response test 1220 is also included in an attempt to limit registration to humans. Once information is provided and terms and conditions accepted, button 1230 can be selected to submit the registration information. Subsequently, a user may need to activate his/her membership by selecting a link received in an e-mail, for example.

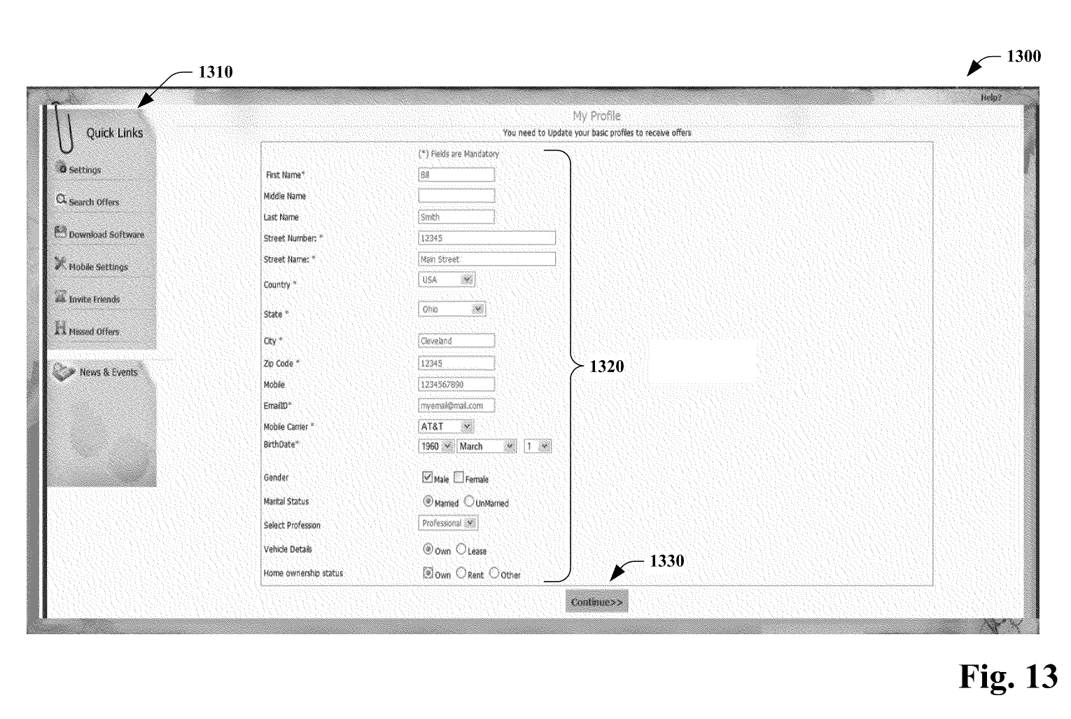

Once a member, screenshot 1300 of FIG. 13 can be presented to a user to collect profile information. Similar to the advertisers' interface, a “Quick Links” portion can be provided for consumers to enable quick access to enable changes to settings, offer searching, software download, alteration of mobile settings, inviting friends, and identifying missed advertisements. A myriad of text boxes, drop down menus, check boxes and buttons are provided to acquire information 1320. Profile information includes first name, middle name, last name, address, mobile phone number, e-mail address, mobile carrier, birth date, gender, marital status, profession, vehicle details (e.g., own, lease) and home ownership status (e.g., own, rent, other). Once finished entering information, button 1330 can be selected to save the information and continue on to specification of settings or preferences.

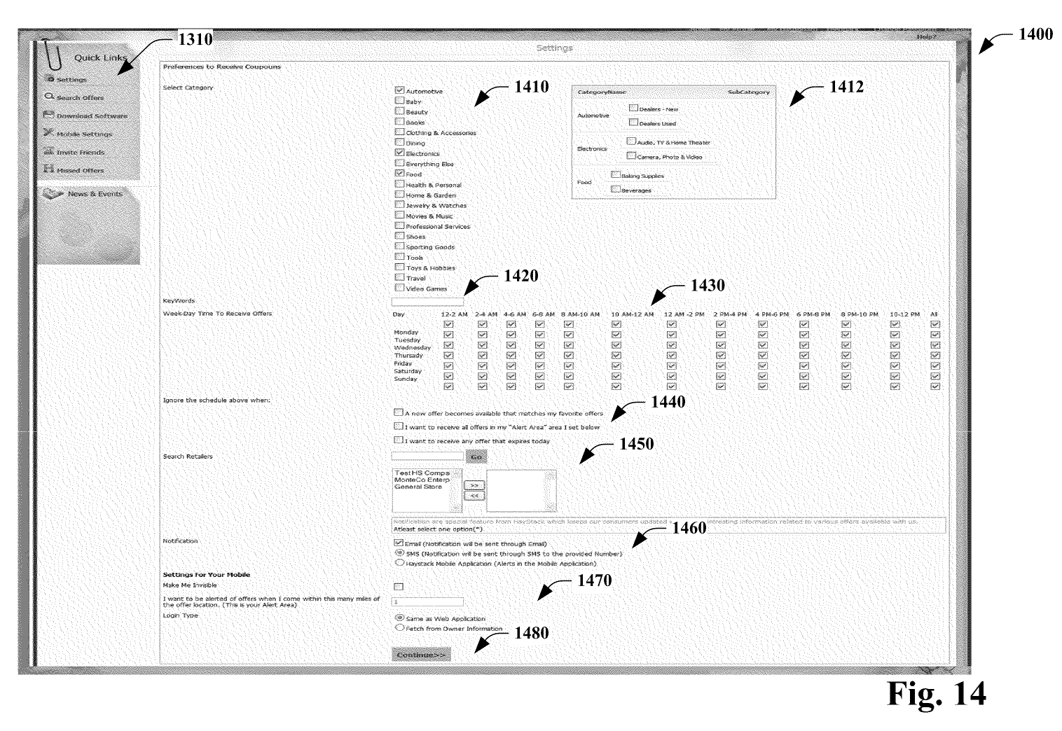

FIG. 14 is a screenshot 1400 of graphical interface utilized to collect setting information from users. First, a plurality of check boxes 1410 are provided to select one or more categories of interest such as automotive, baby, beauty, books, clothing and accessories, dining, electronics, food, heath and personal, home and garden, jewelry and watches, movies and music, professional services, shoes, sporting goods, tools, toys and hobbies, travel and video games. For each of these categories subcategories can be selected by way of a plurality of check boxes 1412. For example, automotive subcategories include dealer new and used. Keywords of interest can be specified in text box 1420. In addition a schedule for advertisement delivery can be specified by selecting or deselecting checkboxes associated with times and days of the week. This schedule can be ignored in particular circumstances as specified by selection of one or more check boxes 1440. For example, the user may want advertisements associated with his/her favorites or that expire today. Particular retailers, merchants, or brands can be specified via a mechanism at 1450. Manners in which notification should be provided can be specified by selecting one or more buttons or checkboxes 1460 corresponding to e-mail, SMS, or application. Mobile device settings can be specified at 1470 through one or more interface elements. By way of example, a user can indicate that they would like to be invisible to the system, alerted of offers within a particular alert area, and specify a manner of mobile login. Once a user is finished specifying settings button 1480 can be selected to save information.

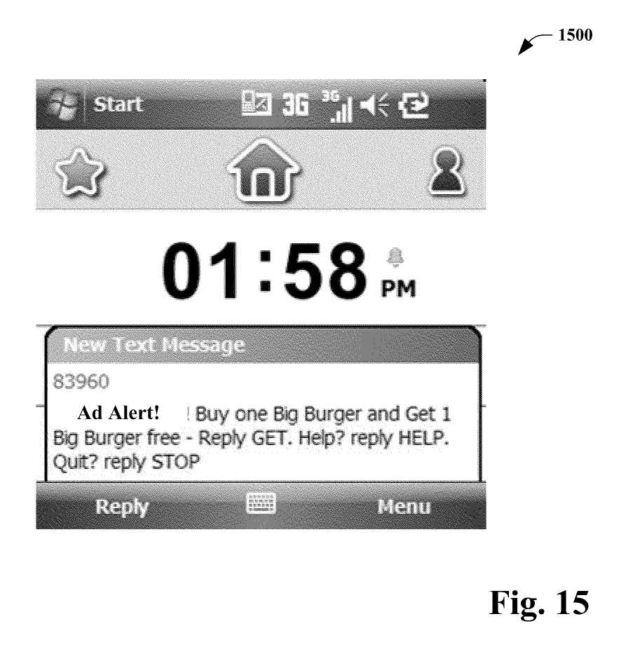

Assuming that the consumer profile and settings correspond to those specified with respect to the earlier described generated advertisement, a user can receive notification of the “Burger Offer” on his/her phone via text message. Screenshot 1500 of FIG. 15 illustrates how the notification could be displayed to the user. As shown, the text message would say “Ad Alert! Buy one Big Burger and Get 1 Big Burger free,” as previously specified by the advertiser. Also noted is that the user can send a reply text message with “GET” to acquire a corresponding coupon or promotional code, “HELP” for obtaining assistance and “STOP” to halt subsequent notifications.

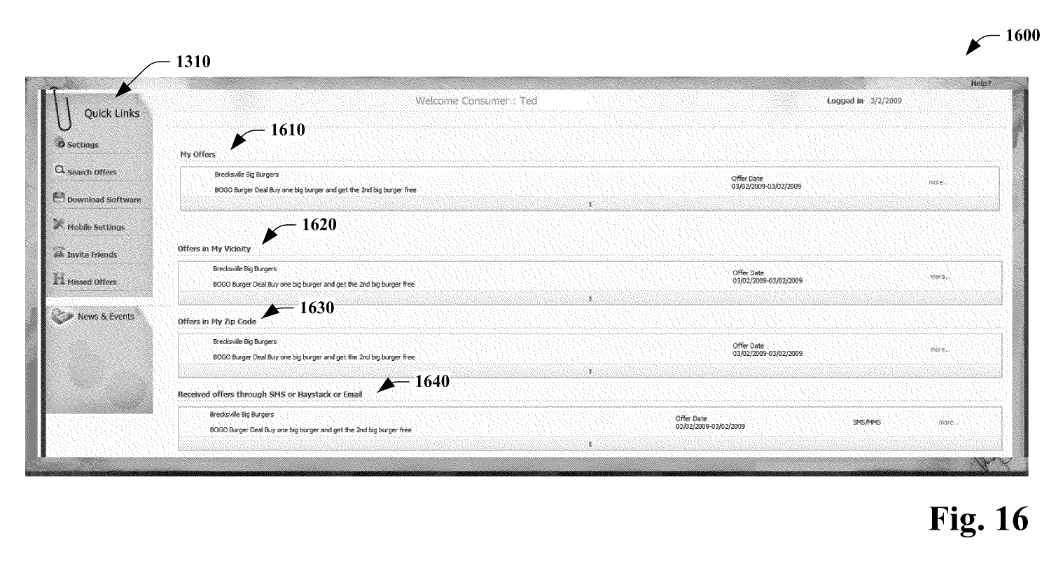

Screenshot 1600 of FIG. 16 illustrates another manner in which offers can be obtained in a format that resembles registration, profile and settings input. In particular, upon selecting “Search Offers” from the “Quick Link” portion 1310, screenshot 1600 can result. Portion 1610 identifies user offers or more specifically “My Offers,” which can correspond to those offers the user has activated and/or saved, for example. Additional portions enable a user to view offers in the user's vicinity 1620, zip code 1630, or those offers received through SMS, application, or e-mail 1640.

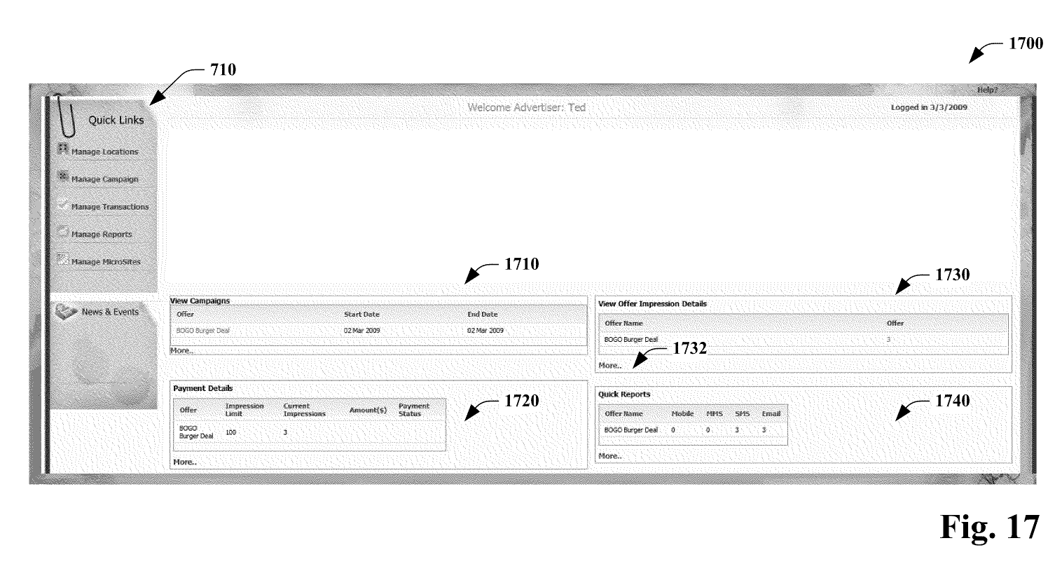

FIGS. 17-20 are screenshots pertaining again to the advertiser. However, these particular screenshots relate to viewing of information related to campaigns. Referring first to FIG. 17, screenshot 1700 provides broad details about campaigns. In particular, section 1710 identifies campaign names as well as start and end dates. Section 1720 provides payment details. Here, it is noted that the “BOGO Burger Deal” has an impression limit of one hundred and currently there have been only three impressions. Other information includes amount due as well as payment status. Section 1730 includes offer impression detail including the name of the offer and number of impressions. Section 1740 includes quick reports with information identifying offer name and impression by mobile application, MMS, SMS, and e-mail.

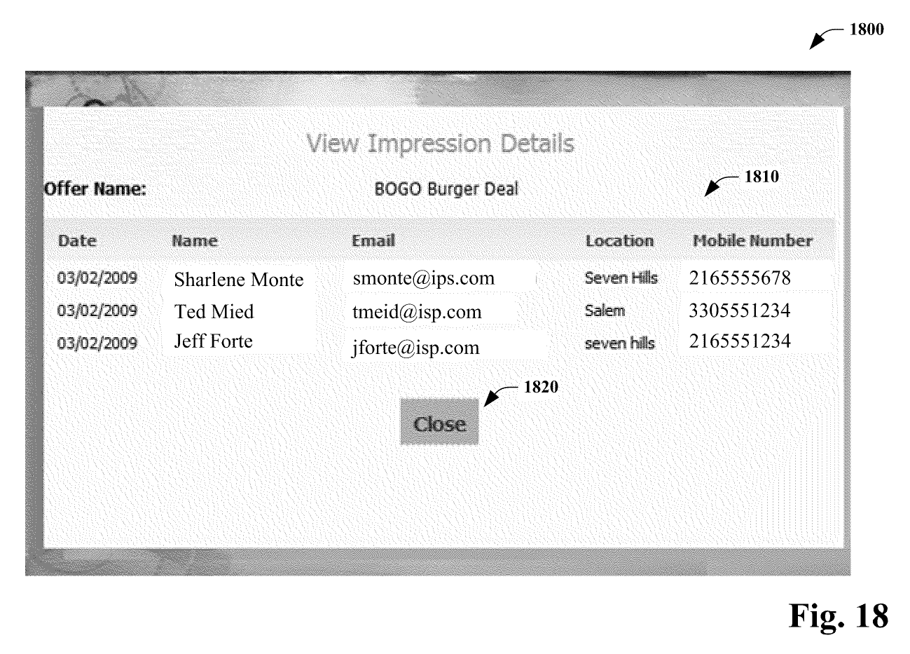

Should the advertiser desire additional impression details about a particular offer, they can click on the offer or on “more” link 1732. Such an action can result in presentation of screenshot 1800 of FIG. 18, which reveals information about each consumer who received the offer 1810 including date, name, e-mail address, location, and mobile number. Also included is a “Close” button 1820 for closing out of the impression details screen and perhaps returning the screenshot 1700.

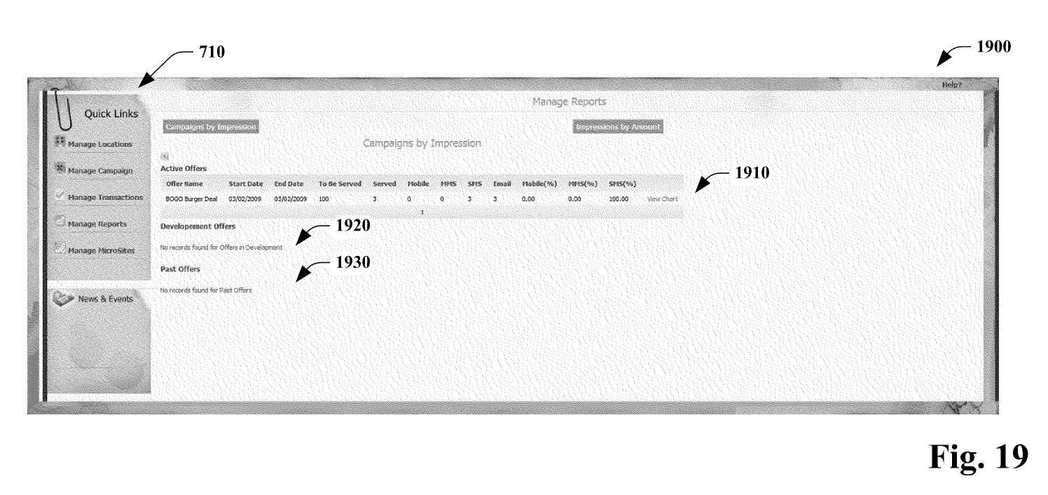

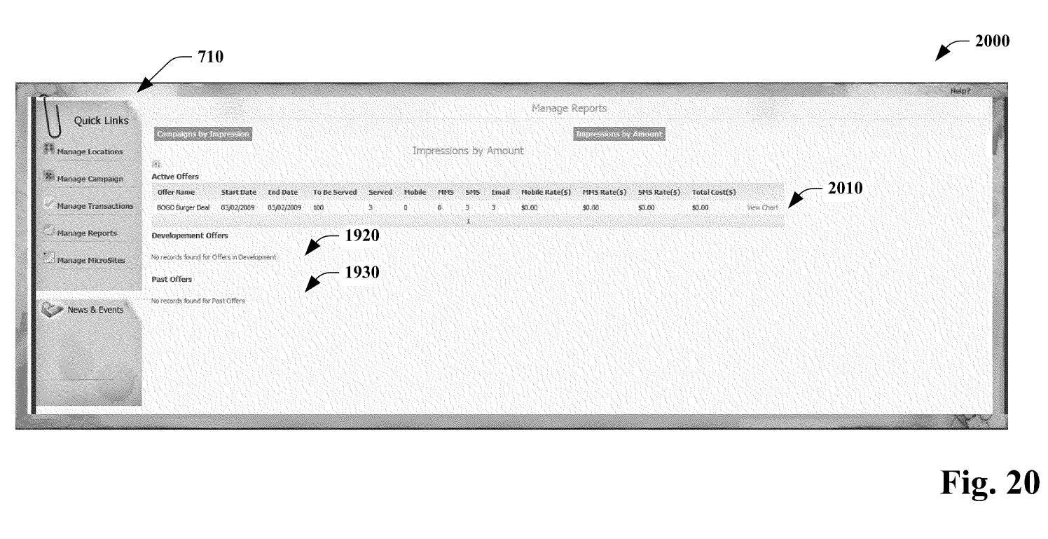

Screenshots 1900 and 2000 of FIGS. 19 and 20, respectively, correspond to additional reports that can be provided to an advertiser. Screenshot 1900 identifies campaigns by impression information. More specifically, active offer information 1910 is specified including offer name, start date, end date, offers to be served, number served, offers served by mobile application, offers served by MMS, offers served by SMS, and offers served by e-mail as well as percentages corresponding to each serving means. Screenshot 2000 details information about impressions by amount. Active offer information 2010 includes offer name, start date, end date, offers to be served, offers served, offers served by mobile application, offers served by MMS, offers served by SMS, offers served by e-mail as well as the rate for serving by each means and total cost. Other information specified by both reports includes information regarding developmental offers 1920 and past offers 1930.

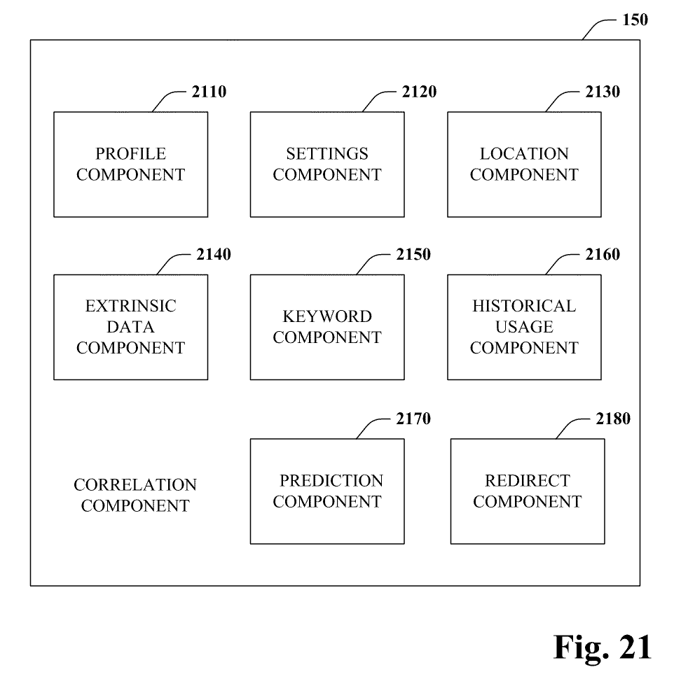

FIG. 21 depicts a representative correlation component 150 in accordance with an aspect of the claimed subject matter. Recall that generally correlation component 150 correlates or matches advertisements to consumers. Matching can be performed in a variety of different ways as a function of a host of different data. Representative correlation component 150 and following description thereof is an attempt to clarify a few ways in which correlation can be performed. Of course, the claimed subject matter is not limited thereto.

Components 2110, 2120, 2130, and 2140 pertain to performing correlation with respect to particular kinds of context information. In particular, profile component 2010 enables matching of advertisements based on consumer profile information. For instance, this can include a consumer's age, gender, marital status, profession, ethnicity, and/or religion, amongst other information. Settings component 2120 allows correlations based on consumer and/or advertising settings. Consumer setting information can include at least categories and subcategories of interest, preferred retailer, and designated time for receiving offers. Advertiser settings can specify characteristics relating to a preferred recipient including, among other things, age, gender, and interests/hobbies as well as campaign categories and subcategories, geographic limits, and keywords for example. Location component 2130 enables matching based on at least consumer location. Extrinsic data component 2140 allows correlation as a function of extrinsic data including without limitation temperature, weather, barometric pressure, altitude, time of day, day of week and/or season. While the correlation component 150 can match based on each of these pieces of contextual information separately, it can also match as a function of all or combinations of such information.

Keyword component 2150 enables correlation as a function of keywords. In one instance, keywords can form part of user and or advertiser settings and matched in that situation. Additionally or alternatively, the correlation component 150 can be employed to directly search for advertisements of interest. In that case, the correlation component 150 can match based at least upon query key words.

Historical usage component 2160 allows the correlation component to match advertisements as a function of historical advertisement usage. In other words, previously received, activated and/or redeemed advertisements or offers can form a basis for future matching. For example, if a user previously redeemed an advertiser's promotional offer, the same or similar offers can be subsequently matched with higher relevance. Furthermore, it is to be appreciated that historical advertisement usage can be employed with respect to not only a single advertiser and consumer but also across all advertisers as well as all consumers or subsets thereof.

Prediction component 2170 enables the correlation component 150 to make predictions or inferences related to advertisements that may be of interest. In one embodiment, affinity groups can be employed as basis for prediction. For example, utilizing various industry models, spectral clustering, and/or micro-segments users can be determined or otherwise classified as members of one or more affinity groups. Subsequently, predictions can be made for specific consumers as a function of group wants, needs, or desires. Furthermore, predictions can be made as a function of one or more models including industry standard models as well as learned or otherwise acquired behavioral models. By way of example, it is known that if a man purchases diapers at a grocery store he will also likely purchase beer. Accordingly, if it can be determined that such a consumer has purchased or is in the process of purchasing diapers an advertisement for beer can be provided. In another instance, it can be determined that a certain path is followed through a mall or other group of proximate stores such a behavioral model can be utilized to ensure that advertisements are afforded to consumers for retailers on that path as the consumer moves.

Redirect component 2180 provides correlation based on competition. When specified, consumers can be directed away from a first advertiser and to a second advertiser by matching advertisements for the second advertiser when otherwise advertisements for the first advertiser are or would be matched. In other words, consumers are redirected to another advertiser. For example, when a consumer is located within a predetermined proximity of a coffee shop A, then an advertisement for coffee shop B can be matched and delivered.

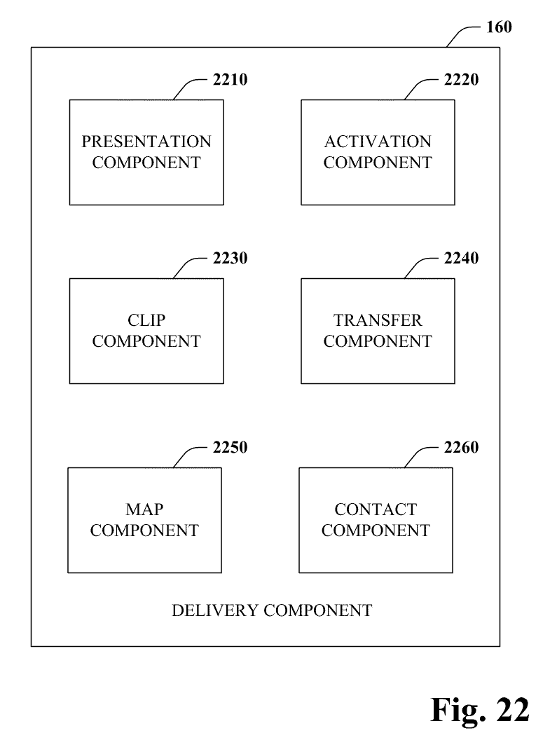

FIG. 22 depicts a representative delivery component 160 in accordance with an aspect of the claimed subject matter. The delivery component 120 includes a presentation component 2210 that provides an advertisement or information about an advertisement to a user. The actual mechanism employed by the presentation component 2210 varies based on preferences/settings and device capability, among other things. For example, an advertisement can be delivered by text message (SMS), multimedia message (MMS), e-mail, or through an application. One or more distribution mechanisms can be employed by the presentation component 2210 to provision advertisements to consumers. For example, information about a promotional offer can be provided to a user via text message as well as e-mail. Moreover, context can be accounted for in determining the best means of notification.

Activation component 2220 enables an advertisement to be activated. As previously described, rather than providing a full advertisement or offer to a consumer upon matching, the consumer can simply be notified of the advertisement. Subsequently, if desired, the advertisement or offer can be requested and acquired. In such a scenario, the presentation component 2210 described above can provide the notification functionality. Activation component 2230 receives a request for a particular advertisement that the consumer was notified of and activates or provides the advertisement to the requesting consumer. The request portion of activation can be performed utilizing different means or mechanisms, which can be dependent upon the notification means. For example, where a consumer is notified of an advertisement by text message, then the consumer might request the advertisement by texting “GET” or the like in a reply to the notification. Alternatively, activation can require calling a particular phone number or e-mailing a specific address, among other things. Once requested the actual advertisement or offer can be provided to the user by the activation component 2220 via the same or a different communication medium.

Clip component 2230 is a mechanism for saving an advertisement. Similar to physically clipping or cutting out a coupon, clip component 2230 can save an advertisement or coupon for later viewing, redemption, among other things. By way of example, once a user receives a promotional offer, after activation or otherwise, an option can be provided to clip the offer. If selected, the clipping can be noted by the clip component 2230, and recorded, stored or the like in any manner that enables later retrieval by the consumer.

Transfer component 2240 provides functionality for transferring an advertisement to another consumer. If a consumer acquires an advertisement, offer or the like that he/she believes another person (e.g., friend, family member, colleague . . . ) would desire, it can be transferred to the person utilizing the transfer component 2240. Of course, the means of transfer can vary by capabilities of the sending device and receiving device as well preferences or settings wherein the receiving person is a subscriber, user, member, or the like of the subject advertising system. Transfers to nonsubscribers, nonmembers or the like can be implemented to require subscribing to the advertising service or not.

The delivery component 160 can also include or be associated with a map component 2250 and a contact component 2260 both of which provide added value to advertisement provisioning. The map component 2250 aids a consumer in navigating to a source of the advertisement or offer redemption location. In furtherance thereof, the map component 2250 can provide directions including a map, among other things. The contact component 2260 provides information to facilitate contacting an advertising source such as a retailer. Such information can include an address if not provided by the map component 2250 as well as a phone number and optionally a website if available. In one embodiment, where the retailer operates an online store, the contact component 2260 can direct the user to the store to redeem a promotional offer, for example.

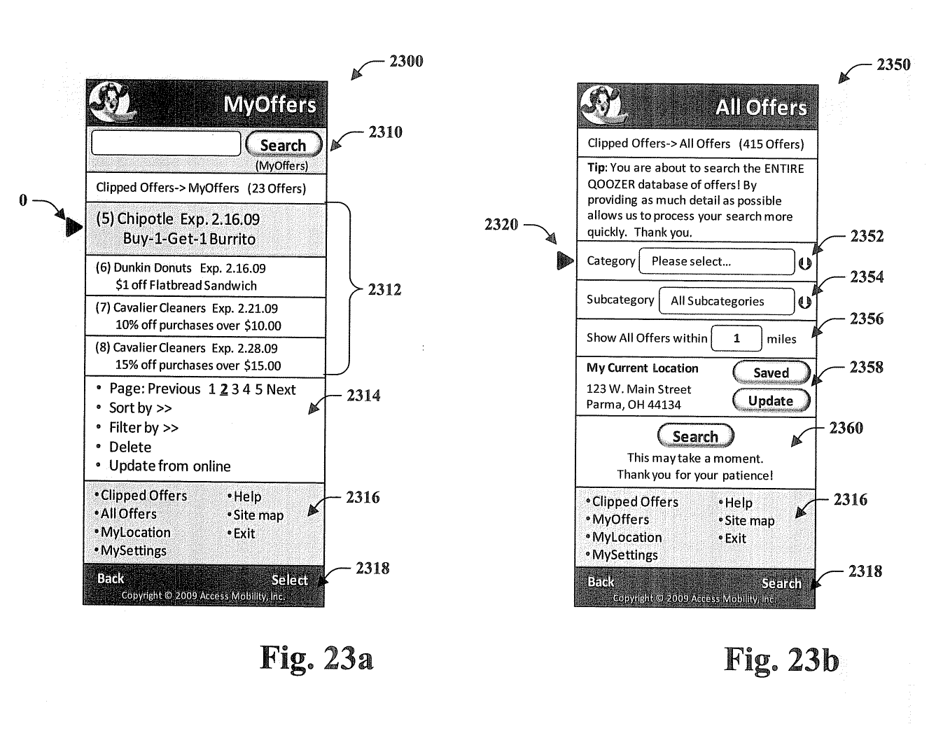

As previously indicated an application can be loaded on a mobile device to enable provisioning of at least a portion of mobile marketing functionality. To facilitate clarity and understanding with respect to operation of such an application, FIGS. 23a-b and 24a-b provide exemplary screenshots. Naturally, such an application can be implemented utilizing various combinations of text, images, audio, and/or video. Accordingly, the claimed subject matter is not intended to be limited by these screenshots.

Referring first to FIG. 23a, an exemplary mobile device screenshot 2300 is depicted in accordance with an aspect of the claimed subject matter. The screenshot 2300 generally relates presentation of a user's offers or “MyOffers,” for example those that currently match the user's settings. A search textbox and button are shown at 2310 to enable queries to be received and executed over a set of offers. A plurality of offers 2312 are shown in list form. For example, these can be a subset of all offers and potentially results of a search. Section 2314 provides a host of options and functionality relating to the display of offers 2312. In particular, links are provided to enable paging up and down, sorting, filtering, deleting, and updating offers from online (e.g., refresh offers and include any offers that were saved utilizing an online/web version). Section 2316 relates to navigation to other pages or screens including clipped offers, all offers, my location, my settings, help, site map, and exit. Finally, footer section 2318 provides functionality to move the user back to a previous screen, and select an offer identified by current cursor 2320 position and thereby move a level deeper in the site.

FIG. 23b depicts a screenshot 2350 pertaining to an advance search of offers such as all unexpired offers. Section 2352 affords a mechanism for specifying a category of interest. Similarly section 2354 provides a means for identifying a desired subcategory. A distance from a current location can be specified at 2356 (e.g., 1 mile). Section 2358 identifies consumer location and allows location to be updated as well as saved. A button 2360 is provided to initiate a search as a function of previously entered information. Again, similar to screenshot 2300 of FIG. 23b, a navigation section 2316, footer section 2318 and cursor 2320.

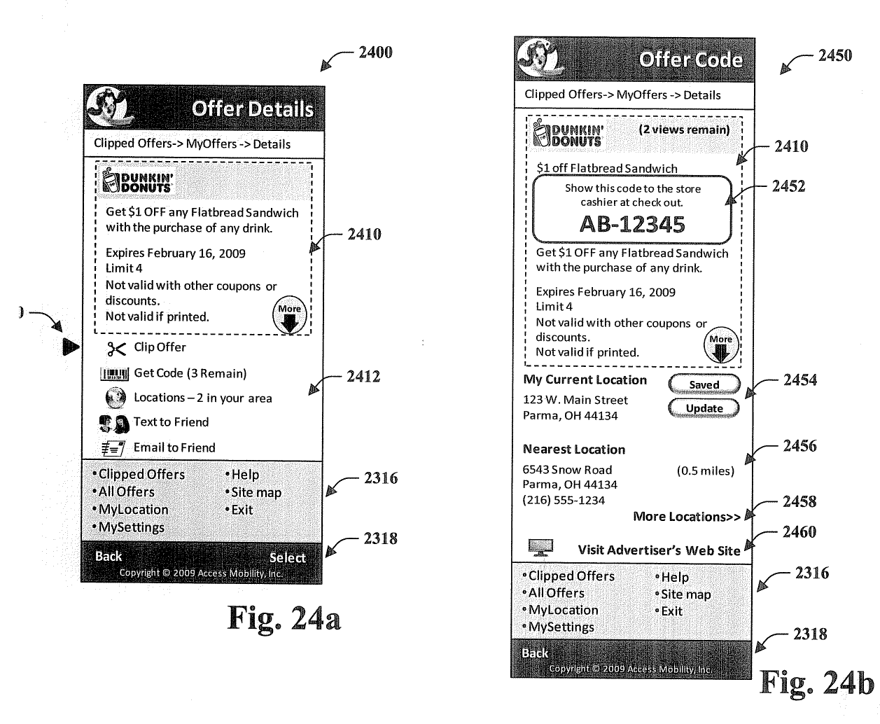

Screenshot 2400 of FIG. 24a shows an exemplary display presented upon selecting or requesting more advertisement details. In particular, a coupon 2410 is presented, namely “$1 off a flatbread sandwich with purchase of a drink.” Section 2412 provides a number of options and functionality with respect to the coupon. For example, the coupon can be clipped or saved, a promotional code received, locations for coupon redemption identified, text the coupon to a friend, or e-mail the coupon to a friend. Navigation section 2316, footer section 2318, and cursor 2320 are also provided as previously described with respect to screenshots 2300 and 2350 of FIGS. 23a and 23b, respectively.

FIG. 24b depicts an exemplary screenshot 2450 associated with a mobile device displaying an advertisement. Here, a coupon 2410 includes a promotional code 2452 that can be provided to a cashier at checkout, for example, to redeem the offer. It is interesting to note that the coupon also indicates that only two viewings of the coupon remain after which the user will not be able to acquire the coupon. This encourages the user to redeem the coupon and helps advertisers manage campaigns, among other things. Section 2454 provides a mechanism for displaying current consumer location as well as updating and saving location information. Section 2456 specifies the location of the nearest store for promotion redemption. Additional locations can be obtained by selecting link 2458. Further, the advertiser's website can be viewed by selecting link 2460. Like other exemplary mobile screenshots, screenshot 2450 includes navigation section 2316 and footer section 2318.

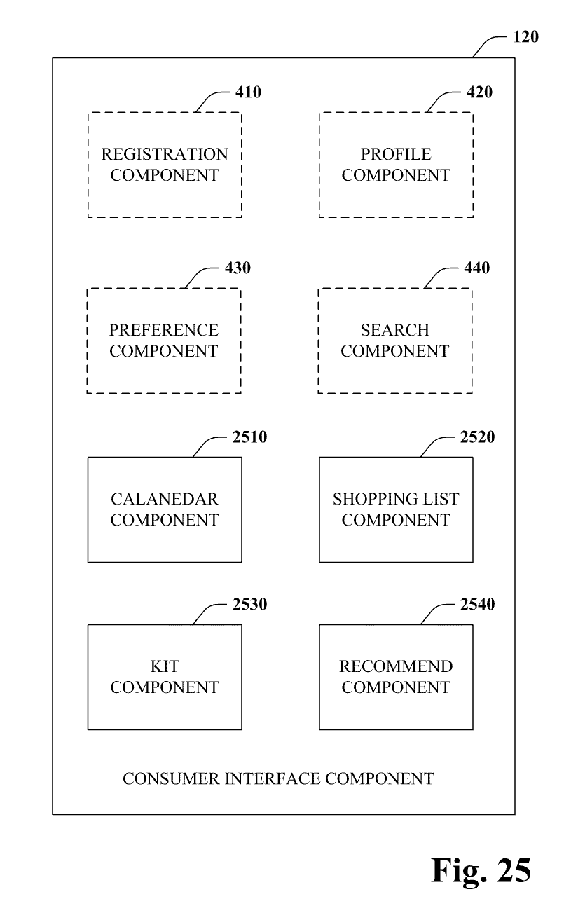

Referring to FIG. 25, a representative consumer component 120 is illustrated in accordance with an aspect of the claimed subject matter. Similar to the consumer component presented in FIG. 4, consumer component 120 includes the registration component 410, profile component 420, preference component 430, and search component 440, as previously described. Among other things, these components aid consumer interaction with a marketing system. The consumer component 420 can also include additional functionality for assisting in acquiring information, as well as providing information.

In particular, the consumer component 120 can include a calendar component 2510 that can facilitate specification and/or acquisition of consumer preferences or other event relevant information. In one embodiment, the calendar component 2510 provides a mechanism to associated preferences or filters and/or categories with particular dates including purchase events. For example, a consumer can add some categories and/or filters to a date associated with a relative's birthday. On or before that date, these filters and categories can be automatically activated. As a result, advertisements will be sent that are tailored to that event. Moreover, users need not specify particular filters but rather can simply identify particular products or services and the calendar component 2510 can automatically generates appropriate filters. Additionally or alternatively, items can be shared with others. For example, one consumer can set up a wish list or the like for events (e.g. birthday, Christmas . . . ) and share them with other users. Upon copying or otherwise receiving this list, the calendar can generate filters automatically and associated them with the particular event date.

Consumer component 120 can also include a shopping list component 2520 that focuses advertisement matching with respect to a particular shopping list. In one embodiment, the shopping list component can aid generation of such a list. Additionally or alternatively, a list can be otherwise acquired such as by upload, download, import or the like. Once acquired, the shopping list can be utilized to adjust categories, filters or the like that influence matching. In one implementation, adjustments based on the shopping list can override at least temporarily other setting since shopping interests are known.

Kit component 2530 enables acquisition of information about kits and employment of the information in modifying categories, filters or the like based thereon. Kits are sets of items employed for a particular purpose. Recipe kits are one example. However, kits can be much more general. For instance, a set of computer equipment including a laptop, mouse, and bag, among other peripherals can be a kit. Upon acquiring information about a desired kit, kit component 2530 identifies kit items and sets filters or the like to facilitate provisioning of promotional offers for the items to enable purchase of the kit at a low cost. It should be noted that a retailer could prepackage all kit items in an attempt to attracted such buyers and offer a discount on the collection of items. Accordingly, a promotional offer associated therewith can be sent to a potential consumer.

The consumer component 120 can also include a recommend component 2540. The subject system is not limited to providing advertisements. In addition or as an alternative, collected information can be utilized to provide retailer advertiser independent recommendations. The same or similar categories, filters, contextual information and the like that are utilized to match advertisements can be employed to simply make suggestions or simply provide valuable information. For example, if a consumer likes pizza for lunch, at lunchtime all local pizza shops can be provided to the user. In another scenario, in a meeting where a salesperson is attempting to land an important client and client representative filters, shopping lists or the like are available, the salesperson can be informed before the meeting that the chief executive officer of the potential client company likes seventeen-year-old scotch.

According to one aspect of claimed subject matter advertisements including promotional offers, coupons and the like can be provided to a user for subsequent redemption at a store. For example, as previously described, an alphanumeric or bar code style promotional code can be provided to a mobile device that can be shown input, shown, scanned or the like at a point of sale. However, claimed subject matter is not so limited in the distribution of promotional offers. In accordance with one embodiment, discounts can be provided to and saved onto loyalty cards or the like. For example, rather than or in addition to providing a promotional offer for a grocery store product to a user via an associated mobile device, the offer can be provided to and saved with respect to the grocery store loyalty card. Accordingly, the discount can be automatically taken on the product upon presentation of the loyalty card. Moreover, the coupon can be provided to multiple loyalty cards for use at more than one store and/or removed after redemption.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, correlation component 150 and delivery component 160 can employ such mechanisms to infer advertisement matches and when and how to deliver matching advertisements.

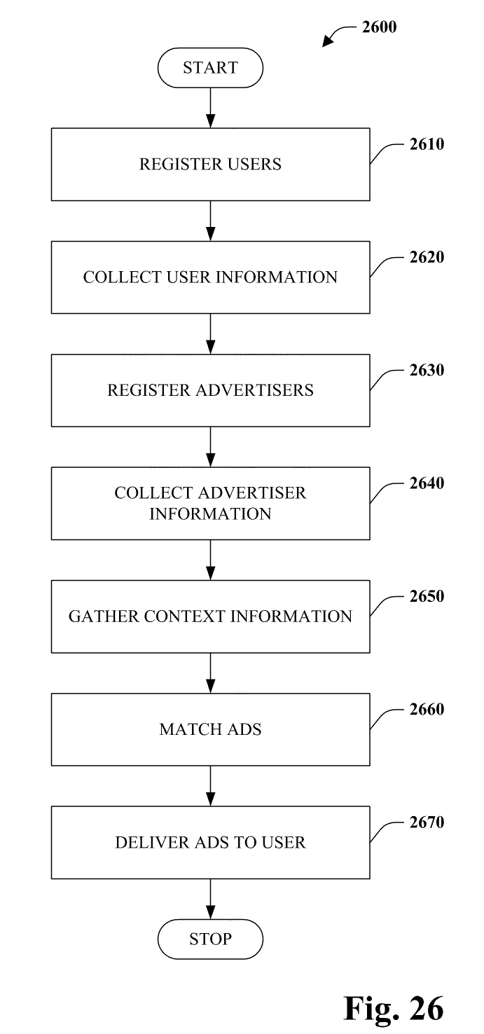

In view of the exemplary systems described supra, methodologies that may be implemented in accordance with the disclosed subject matter will be better appreciated with reference to the flow charts of FIGS. 26-31. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 26, a mobile advertisement method 2600 is illustrated in accordance with an aspect of the claimed subject matter. At reference numeral 2610, users or consumers are registered. In other words, users have indicated their desire to receive advertisements and the like by providing basic information. At numeral 2620, user information can be collected. User information can include among other things user profile, preferences and/or settings. For example, a user can indicate that they are a white male age 28 located in Cleveland, Ohio and are interested in casual dining offers delivered weekdays at lunch time. At reference 2630, advertisers are registered. Similar to user registration, advertisers indicate their desire to supply advertisements and the like by providing basic advertiser information. At reference 2640, additional advertiser information is collected including an advertisement or advertising campaign, details, settings such as campaign categories, subcategories, age range, and gender, as well as campaign validity information including start and end dates, maximum impressions, and deliver times. At numeral 2650, context data can be acquired including location and extrinsic data, among other things. At reference numeral 2660, advertisements are matched to consumers as a function of consumer, advertiser, and/or context information. Matched advertisements can subsequently be delivered to users/consumers at numeral 2670.

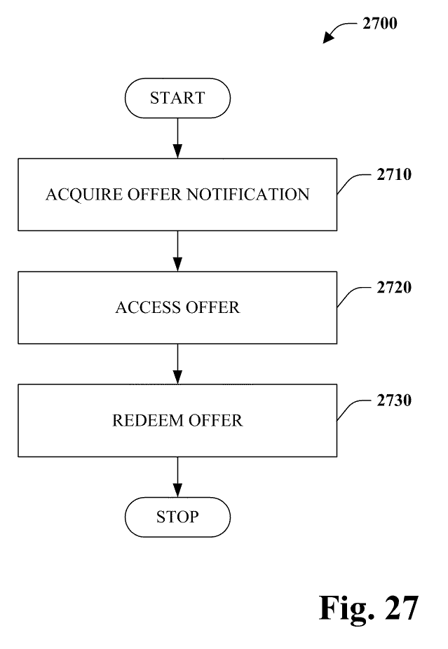

FIG. 27 depicts a method of advertisement employment 2700 in accordance with an aspect of the claimed subject matter. At reference numeral 2710, electronic notification of an offer is provided to a user. For example, such notification can be provided via SMS, MMS, or a local application. In one embodiment, the offer can correspond to products and/or services of interest as determined as a function of one or more of a user profile, user settings, location, and extrinsic data. The notification can provide a brief description of the offer to aid the user in determining whether to further investigate the offer. At numeral 2720, the offer is accessed which includes additional information including a promotional or other unique code (e.g. alphanumeric, bar code), among other things. In one implementation, the offer can be accessed through or with help from the notification. For example, a link can be provided in the notification for navigating to the offer. Alternatively, the notification can facilitate sending a specific text message that will initiate provisioning of the offer. Still further, yet a phone number can be provided in the notification to access the offer. At reference numeral 2730, the offer can be redeemed at a point of sale for purchase of specific products or services. At a physical store, redemption can involve providing the promotional or other code to a user visually, verbally and/or electronically by way of scanning or beaming, for instance. The offer can be redeemed at an online store by entering a particular code or alternatively the code may be automatically entered or provided to the online store. Note that advertisers can pay or be billed for one or more user action including offer notification (e.g. impression), access (e.g., activation), or redemption. Furthermore, utilizing the promotional code and/or another unique tracking number associated with the advertisement, for example, transactional data regarding impressions, activations, and redemptions can be captured and later employed aid advertisement correlation.

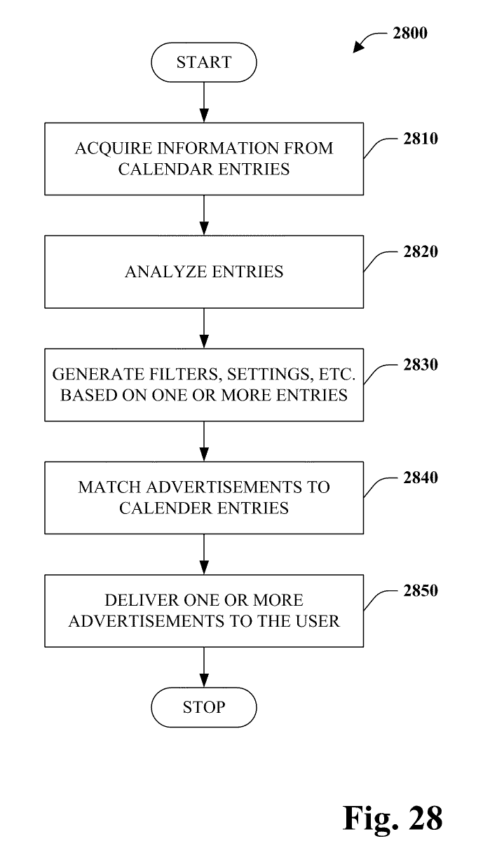

FIG. 28 is a flow chart diagram illustrating a method of advertising as a function of calendar entries in accordance with an aspect of the claimed subject matter. At reference numeral 2810, information is acquired or otherwise identified with respect to a calendar. In one implementation, utilizing a calendar (including calendars provided by a third party), events important to a particular user or otherwise can be captured. Moreover, additional information can be associated with an event. For example, not only can a child's birthday be noted on the calendar but it can also include information pertaining to gifts the child may like. Such products and services can be noted explicitly on such a date or filters or the like can be set that correspond to such products or services. Furthermore, the child can share his or her preferences with the user that can be associated with the date or a birthday wish list or the like can be linked to the date. At numeral 2820, calendar entries are analyzed and at reference 2830 filters, settings or the like are automatically generated based on one or more entries. Not only can filters be generated automatically to transform specifically or generally identified products or services into filters, but additional filters can be added that relate thereto. In this manner, filters can be added that identify potential items that may also be of interest. For example, if a child desires a particular gaming system, then filters can also be generated for associated games. Moreover, generation can be much more complex such that knowledge of interest in a gaming system can imply interest in a particular book for which filters can also be generated. At reference numeral 2840, advertisements are matched to calendar entries for example utilizing generated filters, settings or the like. At numeral 2850, one or more advertisements are delivered to the users at a predetermined time before and even on a particular date. Furthermore, it is to be appreciated that where calendar events employ shared lists, they can operate like a registry such that once someone has indicated that they have purchased something explicitly or implicitly by use of an offer for example, the item can be removed from the list and users will not be provided with coupons for such items.

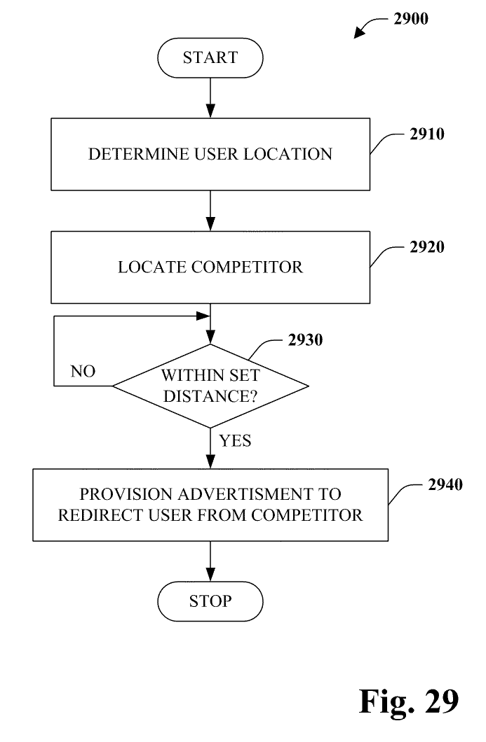

FIG. 29 illustrates a method of advertisement distribution 2900 according to an aspect of the claimed subject matter. At reference numeral 2910, a user's geographical location is determined. For example, location can be determined based on substantially real-time tracking via GPS for instance, utilizing proximity sensors, and/or network transmission triangulation, among other things. At reference 2920, a competitor or competing merchant is located. For example, a competitor's stores can be identified with respect to an address and/or coordinate system. At reference numeral 2930, a determination is made as to whether a user is within a set distance of an identified competitor. If no, the check continues on updated locations. If yes, an advertisement is provisioned to the user to redirect the user away from a competitor location. By way of example and not limitation, consider two coffee shops “A” and “B,” where “B” is an advertiser subscribing to such a service. When a user approaches coffee shop “A,” they can be provided with an advertisement for coffee shop “B.” This is especially helpful to a user who prefers coffee shop “B” to coffee shop “A.” In this instance, an advertisement can be provided with a message identifying the closest location of coffee shop “B.” Where coffee shop “A” is also an advertiser subscribing to services described herein an auction can be held to determine whether an advertisement for coffee shop “A” or coffee shop “B” will be presented upon proximate location of a user.

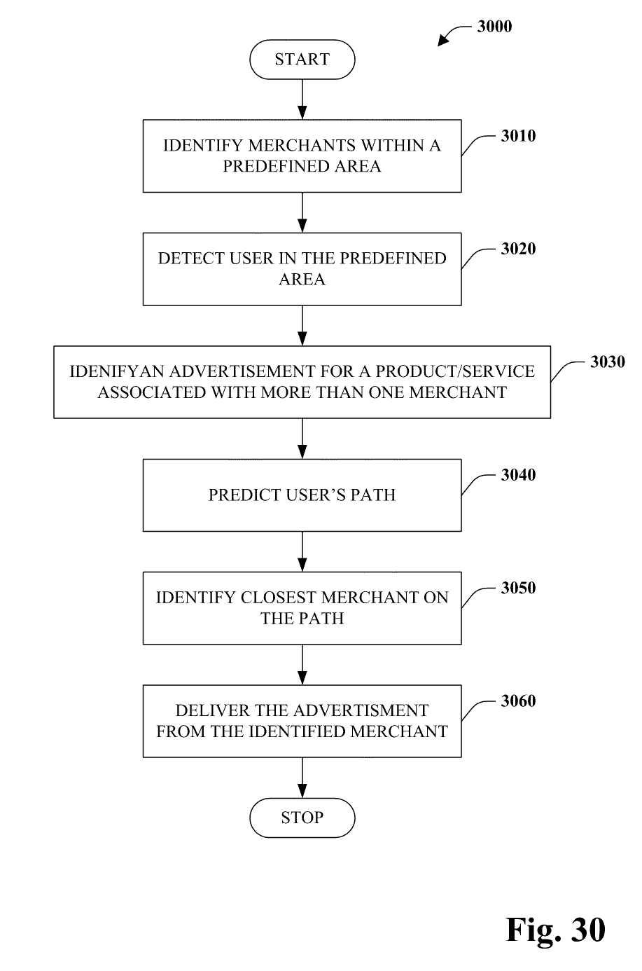

FIG. 30 depicts a method of advertising as a function of a behavior model in accordance with an aspect of the claimed subject matter. At reference numeral 3010, a number of merchants within a predefined area are identified. For example, such merchants can be mall tenants. At 3020, a user is detected within the predefined area. In the example, the user enters or approaches a mall. At numeral 3030, an advertisement for a product or service provided by more than one merchant is identified. A user's path is predicted based on a variety of factors including, among other things historical paths or behavior models. For example, one particular user may visit all stores on a first side and then all stores on a second side while a different user may prefer to visit stores in a zigzag pattern. At reference 3050, the closest advertising merchant on the user's path is identified. Finally, at 3060, the advertisement from the closest merchant is delivered to the user.

While location is a factor in generating a sale, location alone may not be enough. For example, consider a situation in which at the time an advertisement is identified the stores offering a desired product or service are equidistant from a user yet one merchant is behind the user and one merchant is in front of the user in terms of a particular route. For instance, maybe parking caused the user to enter from a different location than normal. It is more likely that an advertisement associated with a merchant on the user route will generate a sale rather than one that requires the user to backtrack or modify his/her route.

Furthermore, merchants within such a predetermined distance that sell the same or similar products or services can simply agree to such a distribution of advertisements or other schemes can be used. For example, merchants can enter into a revenue sharing situation such that a close merchant on a path shares a portion of the purchase cost with a distant merchant or a merchant of a user's path. In this manner, overall sales can be increased and all merchants benefit. Additionally or alternatively, an auction can take place such that an advertisement associated with the closest merchant on the path is not required.

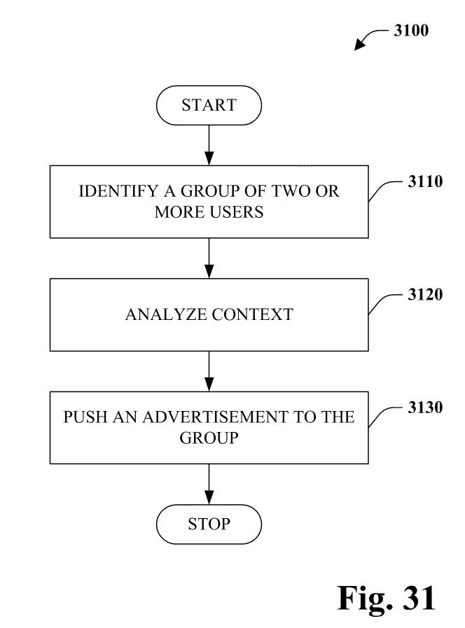

Referring to FIG. 31, a group advertising method 3100 is illustrated in accordance with an aspect of the claimed subject matter. At reference numeral 3110, a group of two or more users i identified. For example, based on GPS location, proximity sensor, or like data it can be determined that number of people or within a set particular distance of one another. At numeral 3120, context is analyzed including each individual's profile, settings and the like as well as other extrinsic information. Furthermore, it should be appreciated that context can include a determined or inferred group activity. Based on this analysis, an advertisement is pushed to one or more members of the group at reference numeral 3130. While the advertisement can simply promote a product or service or offer a discount upon purchase thereof, it can also be couched in more entertaining format so as to encourage the group to talk about it. For instance, it can be a funny video clip or image including reference to the advertiser and an option coupon or discount code.

By way of example and not limitation, consider a situation where a number of colleagues are conversing at the end of a workday. Based on their proximity they can be defined as a group. Thereafter, similarities can be analyzed to produce essentially a group profile, settings, and the like. In this case, it might be determined that the group is interested in beer specials associated with local bars and restaurants. Accordingly, advertisements associated there with can be matched. However, this can further be narrowed by extrinsic data such as the weather. If it is considered nice outside, namely warm and sunny, the advertisements can be further limited to establishments with outside patios. Further yet, if there is a basketball game, which one or more group members plans or would like to attend, then advertisements can further be linked to bars or restaurants close to the event. A matching advertisement can then be provided to one or more of the group members. In one instance, the advertisement can be provided to all group members to improve the effect of an advertisement. However, a group member may not be notified if they have another event that would conflict with meeting colleagues for drinks even though they otherwise would participate. Furthermore, the advertisement may only be provided to a determined group leader such as a supervisor, major or otherwise outgoing individual.

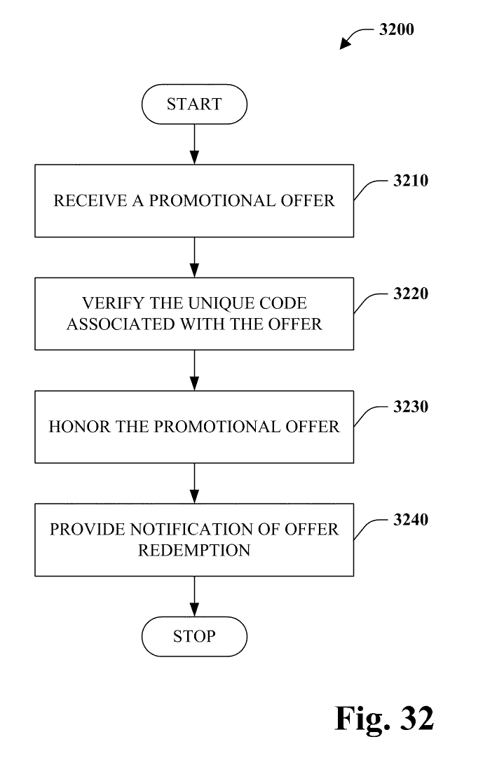

FIG. 32 is flow chart diagram of a method of offer redemption 3200 in accordance with an aspect of the claimed subject matter. At reference numeral 3210, a promotional offer or promotional offer coupon is received. For example, at the point of sale a user can provide a promotional and/or unique tracking code (e.g., numeric, alphanumeric, bar code . . . ) verbally, visually, and/or electronically (e.g. scanner, WiFi, Bluetooth . . . ). At numeral 3220, the unique code is verified, for instance by contacting a mobile marketing system from which the offer was generated. This can ensure not only that the code is valid but also other offer stipulations are satisfied (e.g., validity dates, other product purchases . . . ). At reference 3230, the promotional offer is honored for example by discounting the price of a product or service. Subsequently or concurrently, at 3240, notification is provided of offer redemption. For example, mobile marketing system or some other service can be notified. In one instance, a specific database can be updated to reflect the honoring of the offer.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

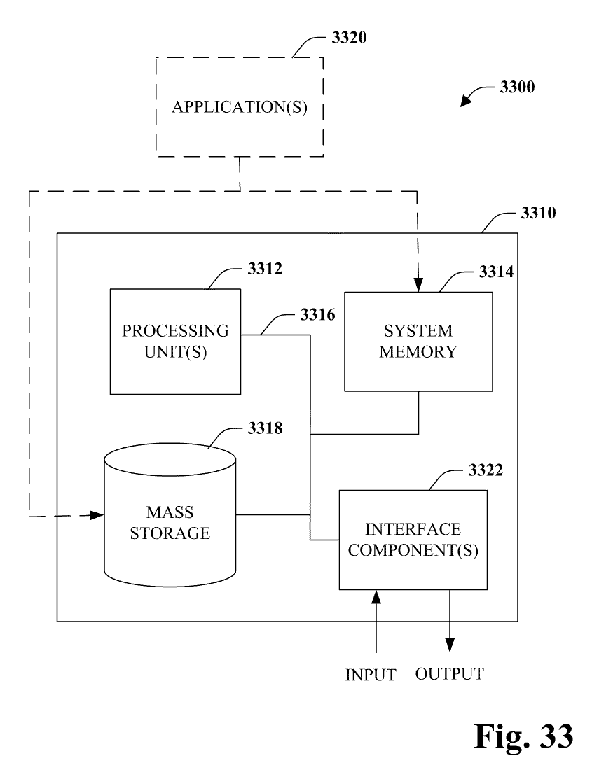

In order to provide a context for the various aspects of the disclosed subject matter, FIGS. 33-35 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 33, an exemplary environment 3300 for implementing various aspects disclosed herein includes a computer 3310 (e.g., desktop, laptop, server, hand held, programmable consumer or industrial electronics . . . ). The computer 3310 includes a processing unit 3312, a system memory 3314, and a system bus 3316. The system bus 3316 communicatively couples system components including, but not limited to, the system memory 3314 to the processing unit 3312. The processing unit 3312 can be any of various available microprocessors. It is to be appreciated that dual microprocessors, multi-core and other multiprocessor architectures can be employed as the processing unit 3312.

The system memory 3314 includes volatile and nonvolatile memory. Volatile memory includes random access memory (RAM), which can act as external cache memory to facilitate processing, among other things. Nonvolatile memory can include, without limitation, read only memory (ROM). For example, the basic input/output system (BIOS), includes basic routines to transfer information between elements within the computer 3310, such as during start-up, is stored in nonvolatile memory.

Computer 3310 also comprises mass storage device(s) 3318 of various types such as removable/non-removable and/or volatile/non-volatile for housing data. Mass storage 3318 includes, but is not limited to, devices like a magnetic or optical disk drive, floppy disk drive, flash memory, or memory stick. In addition, mass storage 3318 can include storage media separately or in combination with other storage media. By way of example and not limitation, mass storage 3318 can correspond to either or both of an internal computer 3310 store and removable store.

FIG. 33 provides software application(s) 3320 that act as an intermediary between users and/or other computers and the basic computer resources described in the suitable operating environment 3300. Such software application(s) 3320 include one or both of system and application software. System software can include an operating system, which can be stored on mass storage 3318, that acts to control and allocate resources of the computer system 33 10. Application software takes advantage of the management of resources by system software through program modules and data stored on either or both of system memory 3314 and mass storage 3318. Accordingly, applications 3320 transform a general-purpose machine into a specific machine that executes particular functionality in accordance with one or more applications 3320.

The computer 3312 also includes one or more interface components 3322 that are communicatively coupled to the bus 3316 and facilitate interaction with the computer 3310. By way of example and not limitation, the interface component 3326 can be a port (e.g., serial, parallel, PCMCIA, USB, FireWire . . . ) or an interface card (e.g., sound, video, network . . . ) or the like. The interface component 3322 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 3310 to output device(s) via interface component(s) 3322. Output devices can include displays (e.g., CRT, LCD, plasma . . . ), speakers, printers, and other computers, among other things.

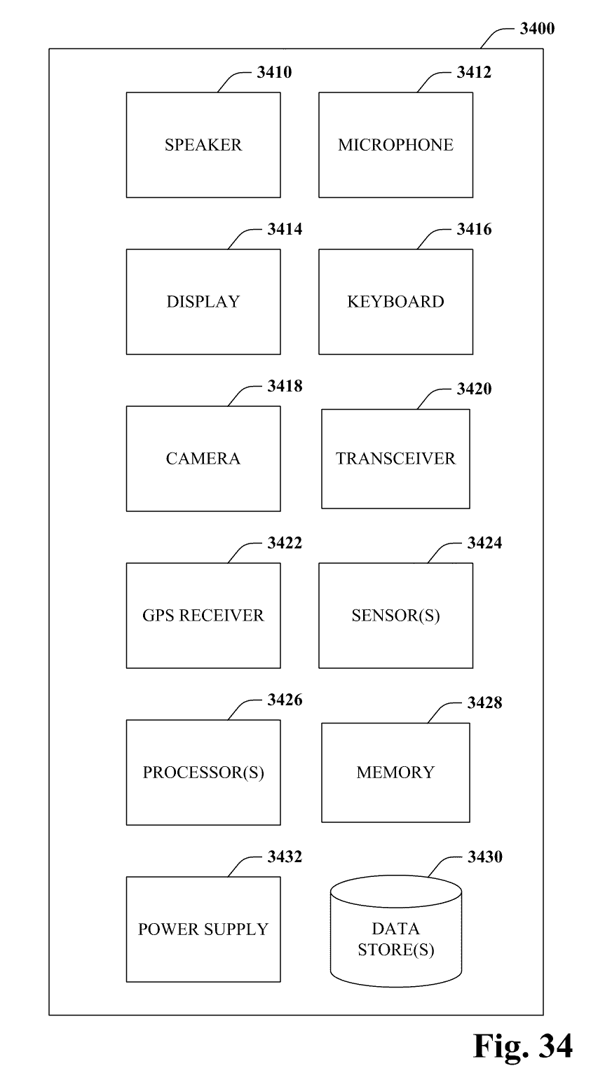

Turning attention to FIG. 34, an exemplary mobile computing device 3400 is shown that can provide a suitable operating environment of at least a portion of claimed aspects. As illustrated, the device 3410 includes at least one speaker 3410 and microphone 3412 for producing and recording audio, respectively. Display 2214 provisions a visual representation of data and information to a user of the device 3400 to facilitate use. In one aspect, the display can be touch-sensitive to enable device functionality to be accessed by touch. Of course, the device is not limited thereto and other means of access or interaction can be provided alone or in combination. For instance, the device 3400 can include a keyboard 3416 to input data and navigate device functionality. Other input mechanism are also possible but not shown include a mouse or trackball, among other things. The device 3400 can also include a camera 3416 to allow capture of pictures and/or video. The camera 3418 can also be associated with a light source to facilitate recording in low light situations.

Transceiver 3420 is a mechanism that enables communication of the device 3400 with other like or disparate devices, access points, and/or networks, among other things. The transceiver 3420 includes functionality for both transmitting and receiving wireless signals. Consequently, the transceiver 3418 can include, or be communicatively coupled to, one or more internal and/or external antennas (not shown). For example, the transceiver can enable voice communication over one or more telephone networks and/or data transmission (e.g., Bluetooth, WiFi, WiMax . . . ).

The mobile computing device 3400 can also include a GPS (Global Positioning System) receiver 3422. The GPS receiver 3422 is able to locate and receive information from a plurality of orbiting satellites. From acquired information, the GPS receiver 3422 is able to compute its location, which can then be employed by the device 3400 or applications executing thereon to provide location dependent functionality (e.g., navigation). Additionally or alternatively, it should be appreciated that cellular transmissions can provide information as a function of signal strength and employment of one or more cell towers, for instance. Other location means or mechanisms are also possible including those associated with proximity and network access (e.g., IP address), among other things.

The device 3400 can also include one or more sensors 3424 for acquiring information pertaining to the device itself or its surroundings. For example, an accelerometer and/or gyroscope can be incorporated into a device to sense movement of the device. This information can then be utilized to aid device interaction. Other sensors 3424 are also possible including, inter alia, an altimeter for measuring altitude or height above a fixed level, a thermometer for quantifying temperature, a barometer for measuring pressure, a hygrometer for sensing humidity, an optical sensor for detecting light, a microphone for sensing sound, a smell sensor for identifying scents, and a proximity sensor for measuring distance from an object or entity.

The computing device 3400 also includes one or more processors 3426, memory 3428, one or more data stores 3430, and a power supply 342. The processor(s) 3426 executes instructions local to the processor and/or housed in memory 3428 to perform some functionality dictated by a hardware and/or software program. The memory 3428 provides volatile and non-volatile storage of data and instructions for expeditious access by the processor(s) 3426. Data store(s) 3430 is a mechanism for persisting large amounts of data and instructions for later use. For example, the device can have an internal data store as well as mechanism to utilize a removable storage device such as a flash memory card or the like. Finally, the device 3400 can include a power supply to enable operation of its component such as but not limited to a rechargeable battery.

It should be appreciated components of the mobile device 3400 are merely exemplary and can vary as a function a mobile device type or configuration, among other things. For example, the mobile device can correspond to a mobile phone in one embodiment. However, the device can also be a personal digital assistant (PDA), electronic book reader, or a gaming system, which necessitate addition of components, removal of components and/or reconfiguration of components.

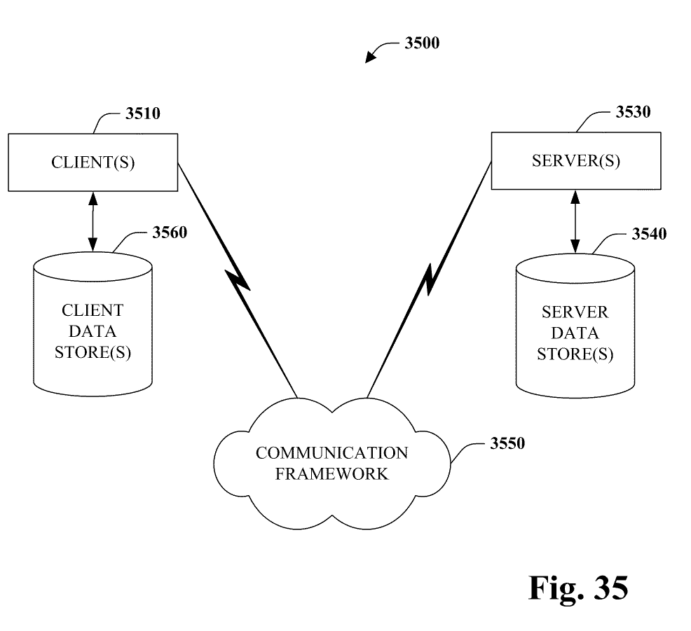

FIG. 35 is a schematic block diagram of a sample-computing environment 3500 with which the subject innovation can interact. The system 3500 includes one or more client(s) 3510. The client(s) 3510 can be hardware and/or software (e.g., threads, processes, computing devices). The system 3500 also includes one or more server(s) 3530. Thus, system 3500 can correspond to a two-tier client server model or a multi-tier model (e.g., client, middle tier server, data server), amongst other models. The server(s) 3530 can also be hardware and/or software (e.g., threads, processes, computing devices). The servers 3530 can house threads to perform transformations by employing the aspects of the subject innovation, for example. One possible communication between a client 3510 and a server 3530 may be in the form of a data packet transmitted between two or more computer processes.

The system 3500 includes a communication framework 3550 that can be employed to facilitate communications between the client(s) 3510 and the server(s) 3530. The framework 3550 can include one or more of many wired and/or wireless communication means including without limitation the Internet and cellular technologies, among others. The client(s) 3510 are operatively connected to one or more client data store(s) 3560 that can be employed to store information local to the client(s) 3510. Similarly, the server(s) 3530 are operatively connected to one or more server data store(s) 3540 that can be employed to store information local to the servers 3530.

Client/server interactions can be utilized with respect with respect to various aspects of the claimed subject matter. By way of example and not limitation, the client(s) 3510 can correspond to a user computer or mobile device such as a phone, which is able to communicate with a mobile marketing system or at least a subset of such functionality executed by one or more servers 3530 across the communication framework 3550. Further, the server(s) 3530 can afford a mobile application comprising mobile marketing functionality that can be downloaded over the communication framework 3550 and subsequently installed by the client(s) 3510. Further yet, all or portions of the mobile marketing system can be hosted by one or more servers 3530 and accessible via one or more clients 3510 including mobile and other computer devices to facilitate input consumer and advertiser information (e.g., profiles, preferences, setting . . . ), for example through an online website.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having,” or variations in form thereof are used in either the detailed description or the claims, such terms are intended to be inclusive in a manner similar to the term “comprising” as “comprising” is interpreted when employed as a transitional word in a claim.

What is claimed is:

1. A mobile marketing system, comprising:
at least one processor that executes the following computer-executable components:
a context component that acquires context including geographical location of a mobile computing device of a user and extrinsic data;
a correlation component that matches advertisements as a function of the context, a user profile, an advertisement profile, and one or more user specified preferences; and
a component that presents at least one matched advertisement to the user by way of the mobile device.

2. The system of claim 1, the correlation component performs predictive matching based on affinity groups.

3. The system of claim 2, the correlation component employs information regarding activated or redeemed advertisement discounts by an affinity group for which the user is determined a member.

4. The system of claim 1, the correlation component matches an advertisement for a preferred good or service merchant when the user is within a predetermined distance of a competing good or service merchant.

5. The system of claim 1, the extrinsic data pertains to presence of a group of users that subscribe to the mobile marketing system and the correlation component matches an advertisement as a function of common group preferences.

6. The system of claim 5, the extrinsic data includes information about an activity with which the group is engage and the correlation further matches an advertisement based on the activity.

7. The system of claim 1, the extrinsic data is predicted user path with respect merchants within a predetermined proximity.

8. The system of claim 1, further comprising a calendar component that enables specification and acquisition of preferences as filters on calendar dates.

9. The system of claim 1, the correlation component matches advertisements as a function of advertiser specified preferences.

10. The system of claim 1, the advertisement is a coupon that can be applied upon purchase of a good or service in accordance with specified terms and conditions.

11. A method of mobile marketing, comprising:
receiving promotional offers from advertisers and offer preferences that specify distribution characteristics;
receiving user preferences identifying desirable offers;
acquiring geographic location of a user of a mobile device and extrinsic data;
matching the offers as a function of location, extrinsic data, user preferences, and offer preferences; and
delivering matching offers to the user electronically by way of the mobile device.

12. The method of claim 11, further comprising electronically notifying the user of the matching offers through the mobile device prior to delivery.

13. The method of claim 12, delivering the matching offers including a promotional code upon request by the user.

14. The method of claim 13, further comprising limiting delivery or viewing of the offers as specified by an advertiser.

15. The method of claim 13, further comprising recording matching offers that were delivered to the user and/or matching offers of which the user was notified.

16. The method of claim 15, further comprising recording the matching offers that were redeemed.

17. The method of claim 16, further comprising generating an invoice for payment as a function of the notification, delivery, and/or redemption of the advertiser's offer.

18. The method of claim 16, further comprising matching offers based on historical transactional information including at least one of notification, delivery, and redemption of offers.

19. The method of claim 11, acquiring extrinsic data comprises obtaining two or more of temperature, weather, altitude, time of day, or day of week.

20. A mobile phone based advertisement system, comprising:
a context component that acquires context including user geographical location from a user mobile phone and extrinsic data;
a correlation component that matches advertiser coupons as a function of the context, user profile, user specified preferences and advertiser specified preferences; and
a delivery component that notifies the user of a matching coupon and provides the matching coupon including a redemption code to the user, upon request, electronically by way of the mobile phone.
